(19) United States
(12) Patent Application Publication
(10) Pub. No.: US 2012/0233095 A1
(43) Pub. Date: Sep. 13, 2012

(54) Analyzing Fluid Release Properties of a Subterranean Area of the Earth

(76) Inventor: Joseph M. Evensen, Houston, TX (US)

(21) Appl. No.: 13/045,525

(22) Filed: Mar. 11, 2011

(51) Int. Cl. G06Q 50/00; G01V 9/00; E21B 47/06

(52) U.S. Cl. 705/413; 73/152.51; 73/152.27

(57) ABSTRACT

A method for estimating a fluid volume in a subterranean area of the earth. The method includes performing a preliminary analysis on a first geological sample and placing the first geological sample inside a chamber. The method may then include monitoring pressure change over time data inside the chamber and crushing the first geological sample. After crushing the first geological sample, the method may estimate the fluid volume based on the pressure change over time data and the preliminary analysis.

### BACKGROUND

1. Field of the Invention

Implementations of various techniques described herein are directed to various methods and/or systems for analyzing properties of the earth and subsurface of the earth.

2. Description of the Related Art

The following descriptions and examples do not constitute an admission as prior art by virtue of their inclusion within this section.

Geological shale or other organic-bearing rocks may release gas at generally ambient to low pressure conditions. The release of gas can be used to estimate the quantities of hydrocarbon gas, such as natural gas, held by those rocks. Currently, the release of gas from shale or coaly rocks is monitored using a canister desorption test. Conventional canister desorption tests involve making a passive measurement of pressure when the gas is released for a long-term period of time, e.g., 30, 60 or 120 days. The canister desorption test is conducted by placing a recently cut shale rock sample, obtained by recent drilling a sample of a rock “core” (core sample), in a sealed container (i.e., canister) and measuring the amount of gas released over a period of time (e.g., 30 days).

Only a rough estimate of gas content inside the core sample may be obtained using this test. The rough estimate of gas content may then be used to estimate gas volume in a subterranean area of the earth that corresponds to where the core sample was obtained. Conventional canister desorption tests are not determinative. For instance, all samples are inevitably exposed to the earth's atmosphere for some variable amount of time prior to being placed in the canister, thereby causing the core samples to lose gas that can never be recovered prior to being analyzed. Also, the seal in the canister may not be air-tight. This variable amount of atmospheric exposure time and lack of seal may subject the core samples to pressure change, resulting in lost measurements (i.e., released gas) that can neither be recovered nor accurately corrected for in the measurements. As such, the reliability and robustness of conventional canister desorption tests are limited due to generally inaccurate assessments of rock-related gas pressure and related applicability to subterranean earth.

### SUMMARY

Described herein are implementations of various techniques for analyzing fluid properties of a subterranean area of the earth. In one implementation, a method for analyzing the fluid properties may include estimating a fluid volume in a subterranean area of the earth. The method may then include performing a preliminary analysis on a first geological sample and placing the first geological sample inside a chamber. The method may then include monitoring pressure change over time data inside the chamber and crushing the first geological sample. After crushing the first geological sample, the method may estimate the fluid volume based on the pressure change over time data and the preliminary analysis.

In another implementation, a technique for analyzing fluid properties may include a method for determining an optimum drawdown pressure for extracting a fluid from a subterranean area of the earth. This method may include performing a preliminary analysis on a first geological sample, placing the first geological sample inside a chamber, initializing a pressure inside the chamber to a first predetermined pressure value, monitoring a first pressure change over time data inside the chamber and crushing the first geological sample. After performing these steps, the method may repeat the above steps using a second geological sample initialized at a second predetermined pressure value to obtain a second pressure change over time data. Using the first and second pressure change over time data and the preliminary analysis, the method may then determine the optimum drawdown pressure based on the.

In yet another implementation, a technique for analyzing fluid properties may include a method for determining an optimum drawdown pressure for extracting a fluid volume from a subterranean area of the earth. The method may include performing a preliminary analysis on a geological sample, placing the geological sample inside a chamber, initializing a pressure inside the chamber to a first predetermined pressure value, monitoring a pressure change over time data inside the chamber and simultaneously crushing the geological sample and modifying the pressure in the chamber a plurality of times. The method may then determine the optimum drawdown pressure based on the pressure change over time data and the preliminary analysis

In yet another implementation, a method for determining an optimum drawdown pressure may include performing a preliminary analysis on a geological sample, placing the geological sample inside a chamber, initializing a pressure inside the chamber to a first predetermined pressure value, monitoring a pressure change over time data inside the chamber and simultaneously crushing the geological sample and modifying the pressure in the chamber a plurality of times. The method may then include determining the optimum drawdown pressure based on the pressure change over time data and the preliminary analysis.

In yet another implementation, a method for determining an optimum drawdown pressure may include performing a preliminary analysis on a first plurality of geological samples that were acquired from a plurality of depths in the drilled zone, placing the plurality of geological samples inside a chamber, initializing a pressure inside the chamber to a first predetermined pressure value, monitoring pressure change over time data inside the chamber and crushing the plurality of geological samples. The method may then include repeating the above steps for a second plurality of geological samples acquired from the plurality of depths at a second predetermined pressure value. After repeating the above steps, the method may then determine the optimum drawdown pressure based on each pressure change over time data for the first predetermined pressure value and the second predetermined pressure value, and the preliminary analysis.

In yet another implementation, a method for determining an optimum drawdown pressure may include performing a preliminary analysis on a plurality of geological samples that were acquired from a plurality of depths in the drilled zone and placing the plurality of geological samples inside a chamber. The method may then include monitoring pressure change over time data inside the chamber and simultaneously crushing the plurality of geological samples and modifying the pressure inside the chamber a plurality of times. After crushing and modifying the pressure, the method may determine the optimum drawdown pressure based on the pressure change over time data and the preliminary analysis.

In yet another implementation, a method for determining an optimum drawdown pressure may include performing a preliminary analysis on a plurality of geological samples that were acquired from a plurality of depths in the drilled zone, placing the plurality of geological samples inside a chamber, monitoring pressure change over time data inside the chamber, simultaneously crushing the plurality of geological samples and modifying the pressure inside the chamber a plurality of times, and determining the optimum drawdown pressure based on the pressure change over time data and the preliminary analysis.

In yet another implementation, a technique for analyzing fluid properties may include a method for determining a fluid type of a geological sample from a subterranean area of the earth. The method may include placing the geological sample inside a chamber, monitoring pressure change over time data inside the chamber, crushing the geological sample, and determining the fluid type of the geological sample based on the pressure change over time data.

In yet another implementation, a technique for analyzing fluid properties may include a method for determining an optimum surface area for fluid yield in a subterranean area of the earth. The method may include performing a preliminary analysis on a geological sample from the subterranean area, placing the geological sample inside a chamber, initializing a pressure inside the chamber to a predetermined pressure value, monitoring pressure change over time data inside the chamber, crushing the geological sample inside the chamber, and determining an optimum surface area for fluid yield based on the pressure change over time data and the preliminary analysis.

In yet another implementation, a technique for analyzing fluid properties may include a method for determining an optimum surface area for fluid yield in a subterranean area of the earth. The method may include performing a preliminary analysis on a geological sample from the subterranean area, placing the geological sample inside a chamber, initializing a pressure inside the chamber to a predetermined pressure value, monitoring pressure change over time data inside the chamber, crushing the geological sample inside the chamber, and determining an optimum surface area for fluid yield based on the pressure change over time data and the preliminary analysis.

In yet another implementation, a method for determining an optimum surface area for fluid yield in a subterranean area of the earth may include performing a preliminary analysis on a geological sample from the subterranean area, placing the geological samples inside a chamber, initializing a pressure inside the chamber to a predetermined pressure value, monitoring pressure change over time data inside the chamber, modifying the pressure inside the chamber at a constant or variable rate, crushing the geological sample inside the chamber, and determining an optimum surface area for fluid yield based on the pressure change over time data and the preliminary analysis.

In yet another implementation, A method for identifying potential fluid yield areas in a subterranean area of the earth, comprising receiving a plurality of fluids-in-place measurements for a plurality of depths in a first well; generating a subterranean mapping of optimum fluid yield areas in the first well based on the plurality of fluids-in-place measurements; repeating steps (a)-(b) for a plurality of depths in a second well to generate a subterranean mapping of optimum fluid yield areas in the second well; and identifying the potential fluid yield areas based on the subterranean mapping of optimum fluid yield areas in the first well and in the second well.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Implementations of various technologies will hereafter be described with reference to the accompanying drawings. It should be understood, however, that the accompanying drawings illustrate only the various implementations described herein and are not meant to limit the scope of various technologies described herein.

FIG. 1 illustrates a schematic diagram of a fluid release system in accordance with implementations of various technologies and techniques described herein.

FIG. 2 illustrates a flow diagram of a method for determining a fluid volume in a subterranean area of the earth in accordance with implementations of various technologies and techniques described herein.

FIG. 3A illustrates a graph of pressure change and time in accordance with implementations of various technologies and techniques described herein.

FIG. 3B illustrates graphs of subsurface depth versus fluid desorption in accordance with implementations of various technologies and techniques described herein.

FIG. 3C illustrates pressure curves used to identify a fluid type of a subterranean area of the earth in accordance with implementations of various technologies and techniques described herein.

FIGS. 4A-4B illustrate flow diagrams of methods for estimating an optimum drawdown pressure for extracting a fluid from a subterranean area of the earth in accordance with implementations of various technologies and techniques described herein.

FIG. 5A illustrates a plurality of drawdown pressure curves in accordance with implementations of various technologies and techniques described herein.

FIG. 5B illustrates a commercial analysis graphs for extracting fluids in accordance with implementations of various technologies and techniques described herein.

FIG. 6 illustrates a flow diagram of a method for estimating an optimum drawdown pressure for extracting a fluid from a drilled zone in a subterranean area of the earth in accordance with implementations of various technologies and techniques described herein.

FIG. 7A illustrates optimum drawdown pressure analysis for six drilled zones in accordance with implementations of various technologies and techniques described herein.

FIG. 7B illustrates an example graph of fluid yields using non-optimized drawdown pressures in accordance with implementations of various technologies and techniques described herein.

FIG. 7C illustrates an example graph of fluid yields using optimized drawdown pressures in accordance with implementations of various technologies and techniques described herein.

FIG. 8 illustrates a flow diagram of a method for determining a fluid habitat of a geological sample from a subterranean area of the earth in accordance with implementations of various technologies and techniques described herein.

FIG. 9A illustrates a graph of fluid content versus time for four geological samples that have been crushed six times in accordance with implementations of various technologies and techniques described herein.

FIG. 9B illustrates pore type distributions in a subterranean area of the earth in accordance with implementations of various technologies and techniques described herein.

FIG. 10A illustrates a flow diagram of a method for determining a micro-optimal surface area for fluid yield using a static pressure in accordance with implementations of various technologies and techniques described herein.

FIG. 10B illustrates a flow diagram of a method for determining a micro-optimal surface area for fluid yield using a dynamic pressure in accordance with implementations of various technologies and techniques described herein.

FIG. 11A illustrates a graph of fluid content versus time for a geological sample that has been crushed six times in accordance with implementations of various technologies and techniques described herein.

FIG. 11B illustrates a graph of fluid content versus time that indicates an optimum surface area of a geological sample for maximum fluid yield in accordance with implementations of various technologies and techniques described herein.

FIG. 11C illustrates a graph of fluid content versus time that indicates an optimum surface area of a geological sample for maximum fluid yield at variable pressure in accordance with implementations of various technologies and techniques described herein.

FIG. 12 illustrates a flow diagram of a method for identifying prospective fluid-containing areas of subterranean earth or for identifying subterranean areas of the earth that have efficient or desired fluid yields in accordance with implementations of various technologies and techniques described herein.

FIG. 13A illustrates subterranean vertical profiles of wells that indicates efficient fluid yield areas for each well in accordance with implementations of various technologies and techniques described herein.

FIG. 13B illustrates subterranean mapping of efficient fluid yield areas in accordance with implementations of various technologies and techniques described herein.

### DETAILED DESCRIPTION

The discussion below is directed to certain specific implementations. It is to be understood that the discussion below is only for the purpose of enabling a person with ordinary skill in the art to make and use any subject matter defined now or later by the patent “claims” found in any issued patent herein.

### Executive Summary

The following provides a brief executive summary of various techniques for analyzing fluid release properties of a subterranean area of the earth.

All rocks including organic rich rocks (e.g., shale rock) buried beneath the earth's surface may contain fluids stored therein. Fluids are generally defined as containing any combination of liquids, gases and/or rare solids. For instance, fluids may include light oil, water, carbon dioxide rich and helium-bearing gas, asphaltene solids, sulfide crystals and the like. In order to extract various fluids from the earth, wells may be drilled to depths within the earth where the fluid-bearing rocks may be located, and in one example, the organic rich rocks may then be fractured to release the fluids stored within them through fluid desorption. In one implementation, geological samples (e.g., rock samples) from depths within the earth may be placed in a pressure controlled chamber. The geological samples may then be crushed while inside the pressure controlled chamber. After crushing the geological samples, the pressure inside the chamber may be monitored over time. The monitoring time after crushing the geological sample may be seconds, as opposed to days as required by conventional canister desorption tests. After obtaining the monitored pressure, the monitored pressure may be scaled up to a field scale of a subterranean area in the earth. The scaled pressure curve can then be used to accurately assess the fluid properties (e.g., hydrocarbon) in the subterranean area of the earth from which the geological sample was obtained.

The above described methods may be used to determine how much fluid is stored in rocks, an optimum pressure for drawing the fluid from the rock, fluid habitats of the rock, optimum surface area for drawing fluid from rock, potential fluid yield areas, amounts of fluid yield and other types of engineering data. The methods described herein may also be used to more accurately determine the available fluid in a well to more efficiently extract the fluid from rocks and other types of commercial data.

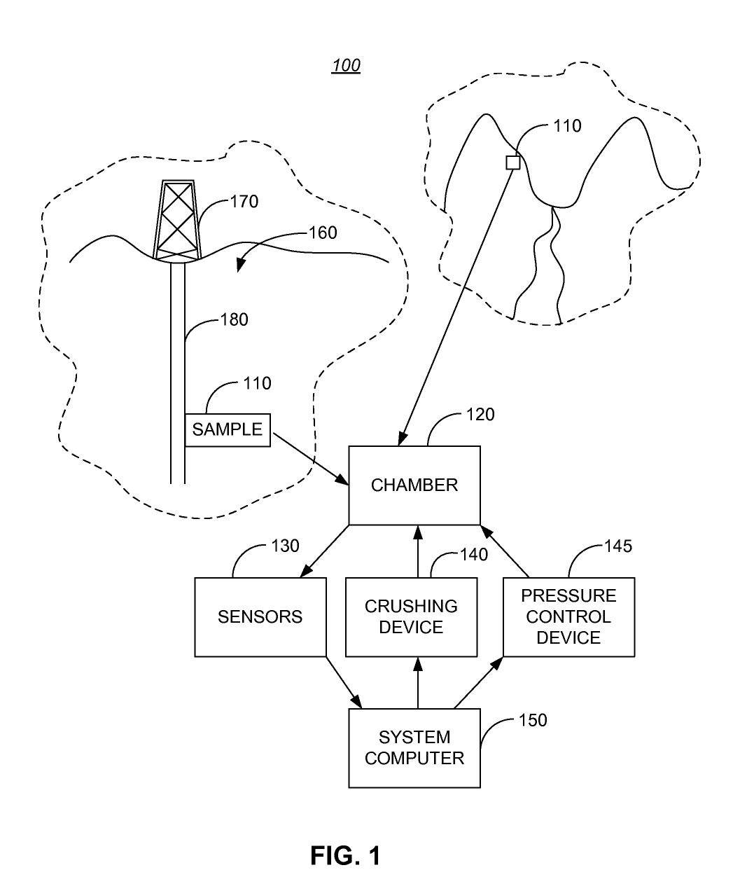

One or more implementations of various technologies and techniques for analyzing fluid desorption properties of a subterranean area of the earth and their various applications will now be described in more detail with reference to FIGS. 1-13B in the following paragraphs.

### Fluid Release System

FIG. 1 illustrates a schematic diagram of a fluid release system 100 into which implementations of various techniques described herein may be implemented. Fluid release system 100 may include geological sample 110, chamber 120, sensors 130, crushing device 140, pressure control device 145 and system computer 150. Geological sample 110 may include rocks, fragments, drill cuttings and the like acquired from a subterranean region of the earth 160. Geological sample 110 may also be obtained from the surface of the earth where fluid-bearing rock may outcrop the surface of the earth. In one implementation, geological sample 110 may be acquired from within or adjacent to borehole 180 that may be drilled under rig 170. In another implementation, geological sample 110 may be acquired from the surface of the earth, such as a mountain region or the like.

Chamber 120 may be a sealed chamber configured to maintain a pressure or range of pressure inside the chamber. In one implementation, the pressure inside chamber 120 may be controlled using pressure control device 145. Chamber 120 may be equipped with various sensors 130 which may be configured to monitor the environment within chamber 120. In one implementation, sensors 130 may include pressure sensors, such as transducers, pressure gauges, bourdon tubes and the like. In addition to pressure sensors, sensors 130 may also include temperature sensors, such as thermocouples or other sensors configured to monitor various environmental factors within chamber 120.

Crushing device 140 may be any type of device configured to reduce the volume of geological sample 110. As such, crushing device 140 may include a device that crushes material using any cutting techniques, chopping techniques, pulverizing techniques, impact techniques, sonic vibration techniques and the like.

Pressure control device 145 may be a device configured to increase, decrease and/or maintain the pressure inside chamber 120. In one implementation, pressure control device 145 may be a vacuum, a pump or the like.

System computer 150 may be implemented as any conventional personal computer or server. However, it should be understood that implementations of various technologies described herein may be practiced in other computer system configurations, including hypertext transfer protocol (HTTP) servers, hand-held devices, multiprocessor systems, microprocessor-based or programmable consumer electronics, network PCs, minicomputers, mainframe computers, high-performance clusters of computers, co-processing-based systems (GP Us, FPGAs) and the like.

System computer 150 is in communication with sensors 130, crushing device 140 and vacuum 145. In one implementation, system computer 150 may control how geological sample 110 may be placed into chamber 120. System computer 150 may include disk storage devices or memory devices which may be used to store any and all of the program instructions, measurement data, and results as desired.

In one implementation, sensor data from sensors 130 may be stored in disk storage devices. System computer 150 may retrieve the appropriate data from the disk storage devices to process the sensor data according to program instructions configured to implement various technologies described herein. The program instructions may be written in a computer programming language, such as C++, Java and the like. The program instructions may be stored in a computer-readable memory. Such computer-readable media may include computer storage media and communication media.

Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the system computer 150.

Communication media may embody computer readable instructions, data structures or other program modules. By way of example, and not limitation, communication media may include wired media such as a wired network or direct-wired connection, and wireless media such as acoustic, RF, infrared and other wireless media. Combinations of the any of the above may also be included within the scope of computer readable media.

In one implementation, system computer 150 may present output primarily onto a graphics display. System computer 150 may store the results of the methods described above on disk storage devices, for later use and further analysis. System computer 150 may also include a keyboard, a pointing device (e.g., a mouse, trackball, or the like) and a printer to enable interactive operation.

### Determining Fluid Volume

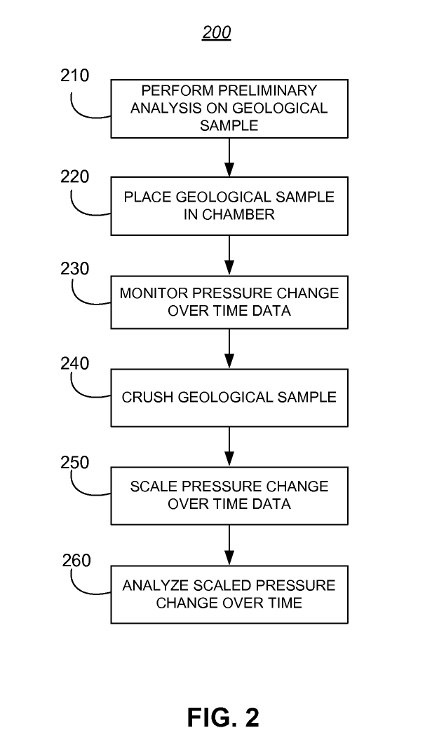

FIG. 2 illustrates a flow diagram of a method 200 for determining a fluid volume in a subterranean area of the earth in accordance with implementations of various technologies and techniques described herein. In particular, method 200 may be used to obtain information about the fluid characteristics of a subterranean area in the earth by crushing a geological sample inside a chamber and monitoring the pressure change inside the chamber due to the crushing.

Method 200 may be characterized as a single pressure (i.e., initial pressure), single crushing, multibaric analysis (i.e., monitored pressure may change during course of analysis), and single subterranean depth sample analysis. However, method 200 may also be characterized as a single pressure, single crushing, and multibaric analysis of multiple subterranean depth samples. It should be understood that while the operational flow diagram indicates a particular order of execution of the operations, in some implementations, certain portions of the operations might be executed in a different order. In one implementation, method 200 may be performed by system computer 150, as described above in FIG. 1. The following description of method 200 is made with reference to fluid release system 100 of FIG. 1.

At step 210, preliminary analysis may be performed on geological sample 110. In one implementation, preliminary analysis may include determining the weight, the density, the mass and similar properties of geological sample 110. The preliminary analysis may be performed by direct measurement or by calculation. The information gathered from the preliminary analysis may be stored in a memory device on system computer 150.

At step 220, geological sample 110 may be placed into chamber 120. Chamber 120 may be configured to maintain a certain pressure within chamber 120, i.e., chamber 120 is sealed. In one implementation, geological sample 110 may be collected by mud loggers while a borehole is being drilled. Typically, mud loggers mark each geological sample collection with its corresponding depth. These collected samples may then be placed into chamber 120 at a later time. Advantageously, method 200 does not require that the collected samples be placed into chamber 120 soon after being pumped out of the earth. In fact, method 200 may be performed on geological sample 110 that have been removed from a surface or subterranean region of the earth at any time prior to being placed in the chamber to estimate the fluid volume in the subterranean area of the earth that corresponds to the geological sample.

At step 230, system computer 150 may begin monitoring the pressure inside chamber 120 over a period of time. The pressure may be monitored using sensors 130, such as pressure sensors (e.g., transducer, a pressure gauge, a bourdon tube and the like). System computer 150 may receive pressure measurements from sensors 130 and store these pressure measurements with reference to the time at which they were acquired in a memory device. System computer 150 may determine the initial pressure of chamber 120 based on the pressure measurements prior to geological sample 110 being crushed at step 240.

In addition to monitoring the pressure change over time, system computer 150 may also measure various environmental factors of chamber 120, such as the temperature. The additional environmental data may be used to assist the scaling function of step 250 described below. In one implementation, the temperature inside chamber 120 may be controlled using a temperature control device. The temperature control device may maintain an iso-thermal environment inside chamber 120 such that temperature changes that occur inside chamber 120 do not affect the pressure values inside chamber 120.

At step 240, system computer 150 may send a command to crushing device 140 to crush geological sample 110 while inside chamber 120. Crushing device 140 may then commence crushing geological sample 110 to reduce the volume of the geological sample. In one implementation, geological sample 110 may be crushed to at least 94%-97% of its original volume. In order to more effectively release the fluid stored within a geological sample, crushing device 140 may crush the geological sample 110 up to approximately 66% of its original volume. In another implementation, fluid may still be released by geological sample 110 as it is crushed up to approximately 33% of its original volume. By crushing geological sample 110, the fluid stored therein may be released via desorption or escape. The released fluid may then alter the pressure inside chamber 120.

As mentioned above, geological sample 110 may have been removed from a subterranean region of the earth at any time prior to being placed in the chamber. In this scenario, although geological sample 110 has been exposed to the atmosphere for an indefinite amount of time, by crushing the geological sample in chamber 120, the fluid trapped inside geological sample 110 may be effectively released and monitored to estimate the corresponding fluid properties in the subterranean area of the earth.

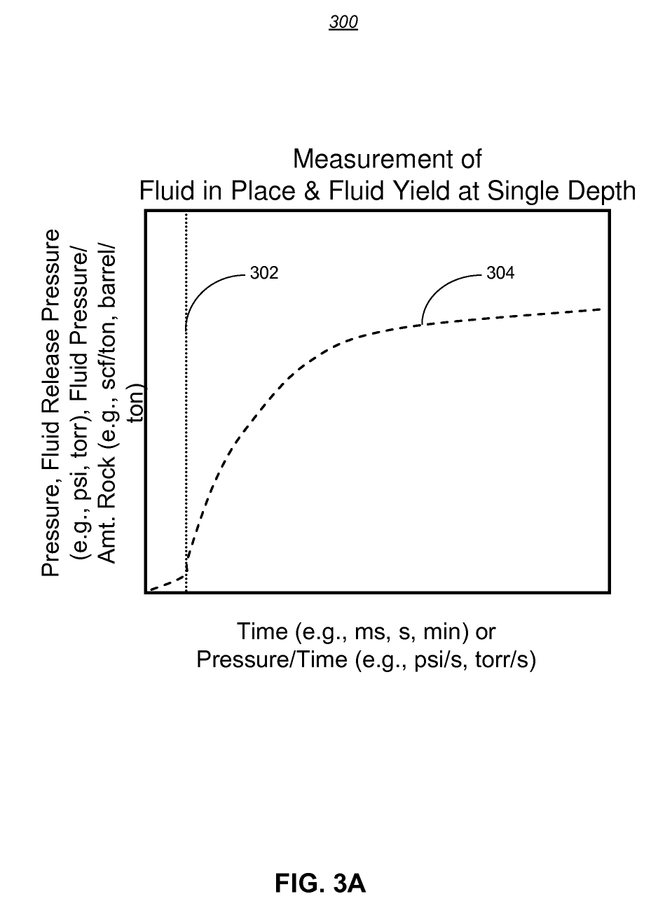

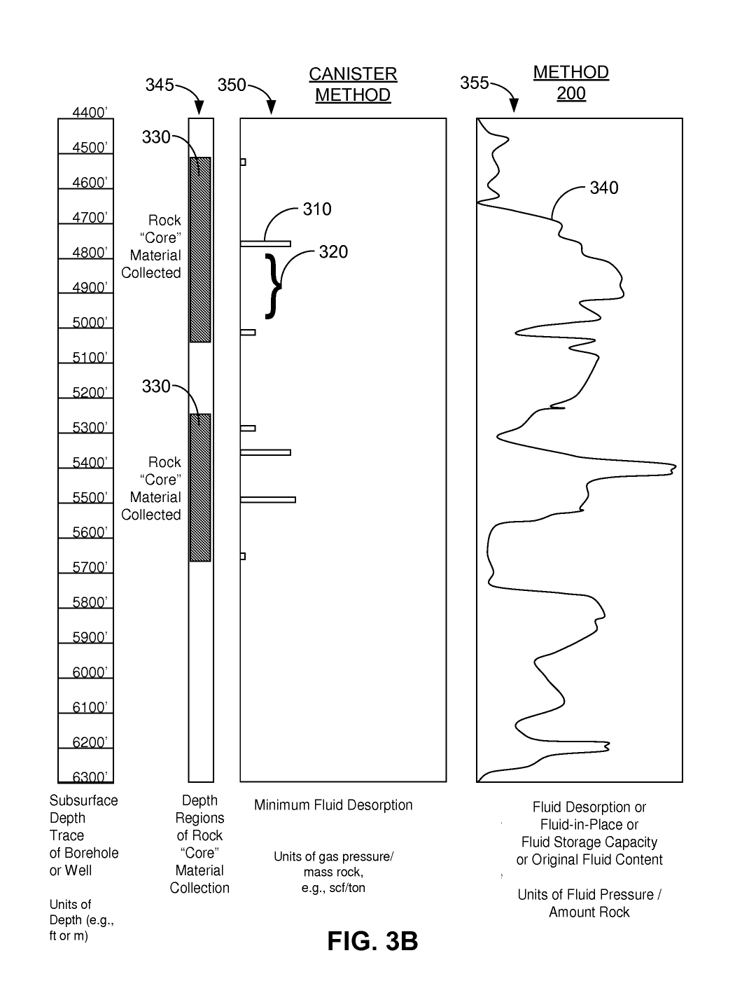

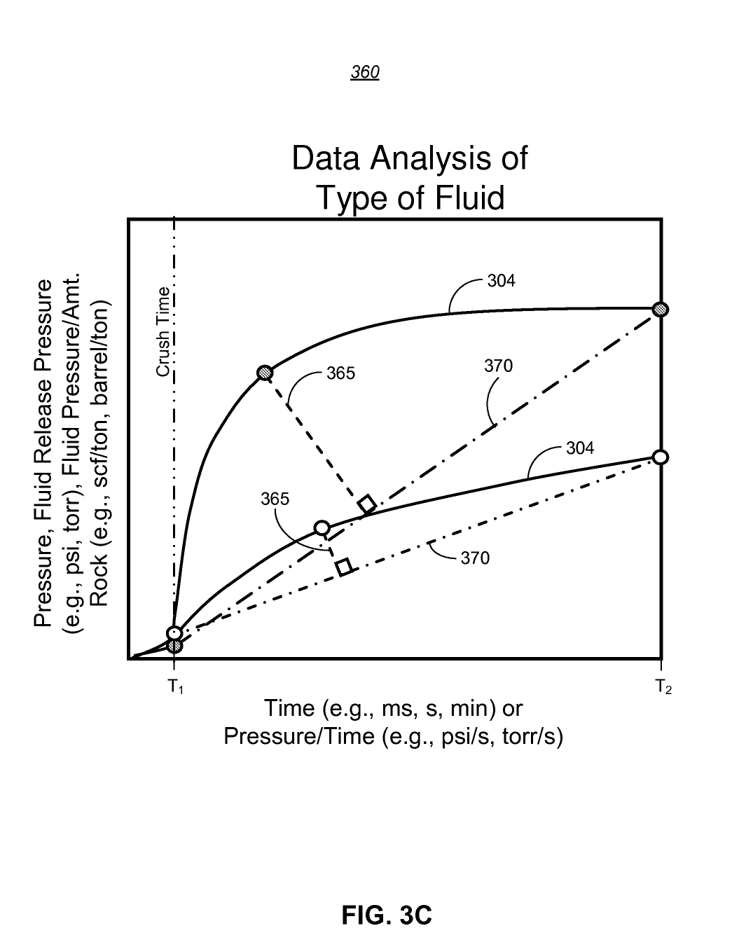

Referring back to step 230, system computer 150 may continuously monitor the pressure inside chamber 120 prior to crushing geological sample 110 (i.e., step 240), while crushing geological sample 110 and after geological sample 110 has been crushed. After crushing geological sample 110, the fluid released from within geological sample 110 may alter the pressure inside chamber 120. While the pressure inside chamber 120 changes, system computer 150 may continue monitoring and recording the pressure values inside the pressure with reference to time. In one implementation, system computer 150 may monitor the pressure inside chamber 120 for less than one minute after geological sample 110 has been crushed. By crushing geological sample 110, the amount of pressure monitoring time needed to estimate the fluid content inside geological sample 110 is reduced to seconds, as opposed to 30, 60 or 120 days, as required for conventional canister desorption tests. An example of the pressure change over time data curve is illustrated in FIG. 3A.

Graph 300 in FIG. 3A illustrates the pressure inside chamber 120 (i.e., vertical axis) as a function of time (i.e., horizontal axis). The pressure inside chamber 120 may be measured in psi, torr or the like and time may be measured in increments of milliseconds, seconds, minutes or the like. In FIG. 3A, the time at which geological sample 110 is crushed is indicated at time 302. The pressure change over time data is indicated with curve 304. As seen in curve 304, the pressure substantially increases after geological sample 110 is crushed.

At step 250, system computer 150 may scale up the pressure change over time data acquired at step 230. Scaling the pressure change over time data may include applying a scaling function to the pressure change over time data to determine the expected pressure change over time data for fluid release of a region of subterranean earth over time. In one implementation, the scaling function may be a linear operation that transforms the pressure change over time data from seconds into days. The scaling function may also use information acquired during the preliminary analysis at step 210 to perform its scaling function. For instance, the scaling function may use the mass of geological sample 110 acquired by the preliminary analysis to linearly scale up the pressure change over time data for a mass that corresponds to the area of the earth where geological sample 110 was acquired. In one implementation, prior to scaling the pressure change over time data, the computer may apply various quality processes to the pressure change over time data to remove noise and obtain higher quality data.

At step 260, computer system 150 may analyze the scaled pressure change over time data to determine various fluid characteristics about the subterranean area of the earth that corresponds to the geological sample. Although the scaled pressure change over time data may resemble data acquired using conventional canister desorption tests, the scaled pressure change over time data will be much more accurate than data acquired using the conventional canister desorption tests. Further, the pressure change over time data may be acquired in a much shorter amount of time than the data acquired using the canister method. Also, method 200 may be applied to all geological samples, as opposed to just recently drilled rock “core.”

### Engineering Applications

In one implementation, the analysis of the scaled pressure change over time data may include determining engineering data. Engineering data may include determining the amount, physical characteristics, distribution of fluids, fluid yields and fluid reserves in the subterranean area of the earth. The engineering data may be used to determine engineering guidelines or facilities requirements for optimal fluid yield and fluid extraction related activities.

Engineering data may be determined using field scaling operations. Field scaling operations may include scaling up the scaled pressure change over time data to determine various characteristics of the field. The field may represent the geological area of the earth from which geological sample 110 was acquired. In one implementation, field scaling operations may include calculating reserves (i.e., rock area from either seismic distributions or mappable distributions) that describe the quantities of fluid that may be commercially recoverable. In another implementation, field scaling operations may include analyzing the fluid value or valuation of the fluid in the subterranean area of the earth. In yet another implementation, field scaling operations may include calculating fluid release results that may give rise to an assessment of the fluids-in-place (FIP), fluid storage capacity, original fluid content, etc. in the subterranean area of the earth. Fluid release results may also be used to determine fluid desorption (i.e., gas desorption/liquid desorption), fluid habitats of geologic materials and the like.

### Commercial Applications

The analysis of the scaled pressure change over time data may also include determining commercial data such as amounts, rates and valuation of commercial resources or reserves. Commercial data may be used to determine valuations and/or cash flow analysis for the fluids extracted from the subterranean area of the earth.

Commercial data may also be determined using the field scaling operations described above. For instance, the field scaling operations may also use scaled pressure change over time data to determine commercial information, such as the reserves. For instance, the reserves may be determined by multiplying the fluid yield with the subterranean area of the earth that corresponds to of the fluid release. The area of the fluid release may be determined using (1) the drainage radius or analogue (e.g., drawdown pressure regimes from associated well or borehole histories) or (2) the mappable area (e.g., using seismic or appropriate analogue).

### Geological Applications

The analysis of the scaled pressure change over time data may also include determining geological/exploration data. Geological/exploration data may include an amount/distribution of fluid, a definition/delineation of amount of fluid, a rock type, a pore type, a fluid type or a fluid habitat of the subterranean area of the earth. A fluid habitat may describe any environment in which a fluid resides within a geological material. A fluid habitat may be affected by a rock type or a rock property of geological sample 110. A fluid habitat may include open pore space, adsorbed, bound, entrapped and mineral surface (i.e., resulting from wetting effects) and the like. In one implementation, the engineering data, the geological/exploration data and the commercial data may be used to determine subterranean mapping criteria or maps themselves for exploration or production of the fluid in the subterranean area of the earth.

### Miscellaneous Applications

Additionally, system computer 150 may use scaled pressure change over time data to determine the hydrocarbon accommodation capacity, the fluid desorption content, the fluid recovery factor, the rate of yield, rock-controlled desorption (kinetic) factors, the volume of the gaseous rocks (or reservoir rocks), the hydrocarbon yield (or other fluid yield) at the surface (e.g., formation volume factors), the recoverable fluid reserves from the subsurface fluid fields and the like. The analysis results may then be used to create commercial or economic interpretations that may include a decline curve over the life of a well, a production curve over the life of a well and the like.

### Application Assumptions

In order to perform field scaling operations, system computer 150 may use some assumptions and variables. For instance, in order to determine the fluid yield/extraction from the subterranean area of the earth, system computer 150 may use predetermined values for abandonment subterranean pressure of zone, formation, field, well or the like. Similarly, in order to calculate the reserves available in the subterranean area of the earth, system computer 150 may use predetermined drainage area or mappable areas of the subterranean area of the earth. Further, system computer may use predetermined values for engineering guidelines and facilities requirements such as compression, fluid lifting (gas lifting), pumping or the like to determine fluid extraction values and fluid extraction procedures.

### Alternate Implementations

In one implementation, at step 240, system computer 150 may send a command to crushing device 140 to continuously (i.e., at a continuous rate) crush geological sample 110. In this case, pressure data may continuously be monitored while geological sample 110 is being crushed. The pressure change over time data acquired in this implementation may then be scaled at step 250 and used to perform the analysis described in step 260 described above.

In another implementation, method 200 may be performed multiple times using a geological sample acquired at predetermined depth increments (e.g., every 5 feet). Each geological sample may be placed in a cleaned chamber to ensure that residue from the previous geological sample may not interfere with the pressure measurements. By repeatedly performing method 200 with geological samples acquired at various depth increments, system computer 150 may more comprehensively determine the fluid desorption properties of the subterranean region of the earth according to its depth.

### Comparing Method 200 to Canister Technique

FIG. 3B illustrates graphs of subsurface depth versus fluid desorption as acquired in accordance with implementations of various technologies and techniques described herein. Graph 345 illustrates the depths at which rock “core” material is collected (i.e., core area 330). Core area 330 includes an area within a borehole where a particular drill bit may be used to break up a portion of the earth within the borehole.

Graph 350 illustrates projected fluid desorption data 310 for various subsurface depths obtained using a conventional canister desorption method. As shown in graph 345 and graph 350, projected fluid desorption data 310 includes only fluid desorption data in recently drilled rock core area 330. Notably, the fluid desorption data 320 is missing from projected fluid desorption data 310. In this manner, the conventional canister desorption method provides a limited number of data points. Due to the inherent quality problems of the conventional canister desorption method, projected fluid desorption measurement 310 will have some of its signal partly lost. As such, projecting the fluid desorption measurement for the entire vertical profile of the subsurface of the earth may not be accurate due to the limited data points and the low quality data acquired using the conventional canister desorption method.

Graph 355 illustrates projected fluid desorption data 340 for various subsurface depths based on scaled pressure change data acquired obtained using method 200. As shown in graph 355, projected fluid desorption data 340 include many more data points from various depths of a borehole as compared to projected fluid desorption data 310. This discrepancy between projected fluid desorption data 310 and projected fluid desorption data 340 may be caused by unaccounted fluid reserves and inaccurate measurements due to the canister method. In one implementation, because projected fluid desorption data 340 includes a more comprehensive account of the fluid desorption measurement within a borehole, projected fluid desorption data 340 may be used to assess the fluid yield/reserves from a borehole at various depths.

Graph 360 in FIG. 3C illustrates pressure curves 360 used to identify a fluid type of a subterranean area of the earth in accordance with implementations of various technologies and techniques described herein. Graph 360 illustrates the pressure inside chamber 120 (i.e., vertical axis) as a function of time (i.e., horizontal axis). The pressure inside chamber 120 may be measured in psi, torr or the like and time may be measured in increments of milliseconds, seconds, minutes or the like. As mentioned above, after crushing geological sample 110 at step 240, the fluid released from within geological sample 110 may alter the pressure inside chamber 120. While the pressure inside chamber 120 changes, system computer 150 may continue monitoring and recording the pressure values inside the pressure with reference to time. System computer 150 may analyze the pressure change over time data to determine whether geological sample 110 is primarily composed of a gas-rich fluid or a liquid-rich fluid.

In general, if the pressure change over time data curve 304 increases rapidly to an asymptotic-like limit, geological sample 110 may be primarily composed of gas. Alternatively, if the pressure change over time data 304 does not increase rapidly to an asymptotic-like limit, geological sample 110 may be primarily composed of liquid. The manner in which system computer 150 determines whether the pressure change over time data curve 304 represents a gas-rich geological sample or a liquid-rich geological sample is explained below.

System computer 150 may first trace line 370 using pressure change over time data curve 304 from when geological sample 110 was crushed (i.e., T₁) to the end of the monitoring period (i.e., T₂). In one implementation, the monitoring period may be a predetermined amount of time not exceed one minute. System computer 150 may then trace line 365 from line 370 to curve 304. Line 370 may be normal to line 365. Further, line 365 may correspond to the maximum deviation between line 370 and curve 304. Using the lengths of line 365 and line 370, system computer 150 may compute for the ratio between the length of line 365 and the length of line 370. If the ratio exceeds 0.18, system computer 150 may determine that geological sample 110 includes a gas-rich fluid. If the ratio is less than 0.18, system computer 150 may determine that geological sample 110 includes a liquid-rich fluid. Based on the type of fluid identified for geological sample 110, system computer 150 may identify what type of fluid exists in the subterranean area of the earth that corresponds to where geological sample 110 was acquired.

### Determining Optimum Drawdown Pressure for Subterranean Depths

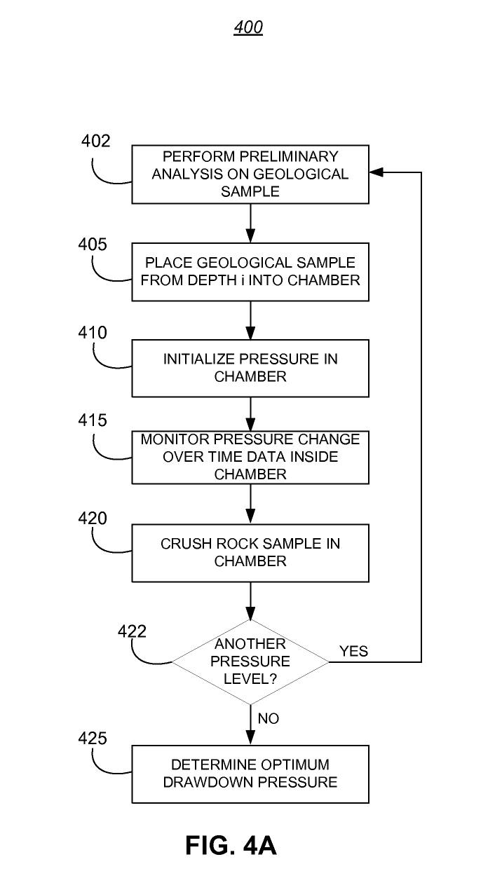

FIG. 4A illustrates a flow diagram of a method 400 for estimating an optimum drawdown pressure for extracting a fluid volume from a subterranean area of the earth in accordance with implementations of various technologies and techniques described herein. In particular, method 400 may be used to obtain the optimum drawdown pressure by crushing geological samples acquired at the same subsurface depth in controlled pressure environments and monitoring the pressure change in each pressure environment due to the crushing.

Method 400 may be characterized as a variable pressure (i.e., variable or multiple pressure conditions), single crushing and single subterranean depth sample analysis. Method 400 may also be used to perform a variable pressure, single crushing analysis for multiple subterranean depth samples. It should be understood that while the operational flow diagram indicates a particular order of execution of the operations, in some implementations, certain portions of the operations might be executed in a different order. In one implementation, method 400 may be performed by system computer 150, as described above in FIG. 1. The following description of method 400 is made with reference to fluid release system 100 of FIG. 1.

The manner of fluid release (i.e., different pressure or vacuum conditions) gives rise to assessment of optimal engineering parameters for fluid extraction (e.g., maximum extraction), such as optimal drawdown pressure (ODP). Drawdown pressure may be related to the pressure at which hydrocarbon or non-hydrocarbon fluids may be efficiently extracted (i.e., using engineering specification for producing fluids) from within the subterranean area of the earth. If fluids are extracted at a pressure that is more than what the subterranean region of the earth is able to sustain, the connections within the earth may break down while the fluids are being extracted and some of the fluids may flow back into the earth and/or the flow of such fluids may be disrupted forever. The optimum drawdown pressure may relate to an optimum pressure at which the fluids within the earth may be extracted from the subterranean area of the earth to yield the maximum amount of the fluids. After determining the optimal drawdown pressure, further analysis may be performed to offer a rate of yield of the fluids stored in a subterranean area of the earth. Additionally, the optimal drawdown pressure may be scaled-up to field scale using linear scaling calculations (or other established scaling functions), thereby offering direct field engineering guidelines for optimal fluid yield (or fluid production) from geologic materials in the subterranean region of the earth. Field Engineering guidelines may also include prescriptively matching fluid yield analysis to a given engineering programs, such as one with specific timeline and amount of fluid production.

At step 402, preliminary analysis may be performed on geological sample 110. In one implementation, preliminary analysis may include determining the weight, the density, the mass and similar properties of geological sample 110. The preliminary analysis may be performed by direct measurement or by calculation. The information gathered from the preliminary analysis may be stored in a memory device on system computer 150.

At step 405, geological sample 110 may be placed in chamber 120. Geological sample 110 may be acquired from a particular depth (e.g., depth i) in a subterranean area of the earth.

At step 410, system computer 150 may initialize the pressure inside chamber 120. In one implementation, system computer 150 may send a command to pressure control device 145 to set the pressure inside chamber 120 to a predetermined level. The predetermined pressure level may relate to a pressure value used to extract fluids from the earth.

At step 415, system computer 150 may begin monitoring the pressure inside each chamber 120. The pressure may be monitored using sensors 130, such as pressure sensors (e.g., such as a transducer, a pressure gauge, a bourdon tube and the like). System computer 150 may receive pressure measurements from sensors 130 and store the measurements with reference to the time at which they were acquired in a memory device. Using the pressure measurements, system computer 150 may track the initial pressure of chamber 120 prior to each geological sample 110 being crushed at step 420.

In addition to monitoring the pressure change over time, system computer 150 may also measure various environmental factors of chamber 120 such as the temperature. The additional environmental data may be used to assist in determining the optimal drawdown pressure, as described in step 425 below. In one implementation, the temperature inside chamber 120 may be controlled using a temperature control device. The temperature control device may maintain an iso-thermal environment inside chamber 120 such that temperature changes that occur inside chamber 120 do not affect the pressure values inside chamber 120.

At step 420, system computer 150 may send a command to crushing device 140 to crush geological sample 110 while inside chamber 120. Crushing device 140 may then commence crushing geological sample 110 to reduce the volume of each geological sample 110 by at least 3-6%. By crushing geological sample 110, the fluid stored therein may be released via desorption. The released fluid may then alter the pressure inside chamber 120.

Referring back to step 415, system computer 150 may continuously monitor the pressure inside each chamber 120 prior to crushing geological sample 110, concurrently while crushing geological sample 110 and after geological sample 110 has been crushed. After crushing geological sample 110, the fluid released from within geological sample 110 may alter the pressure inside chamber 120. While the pressure inside chamber 120 changes, system computer 150 may continue monitoring and recording the pressure values inside the pressure with reference to time. In one implementation, system computer 150 may monitor the pressure inside chamber for less than one minute after geological sample 110 has been crushed.

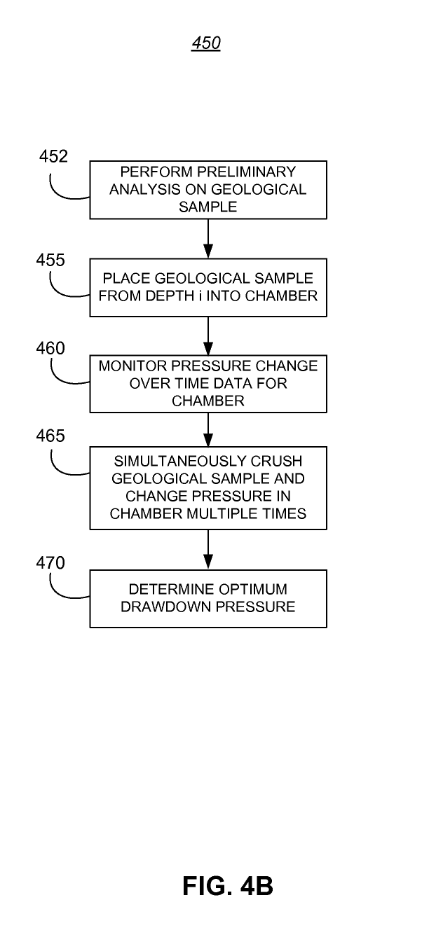

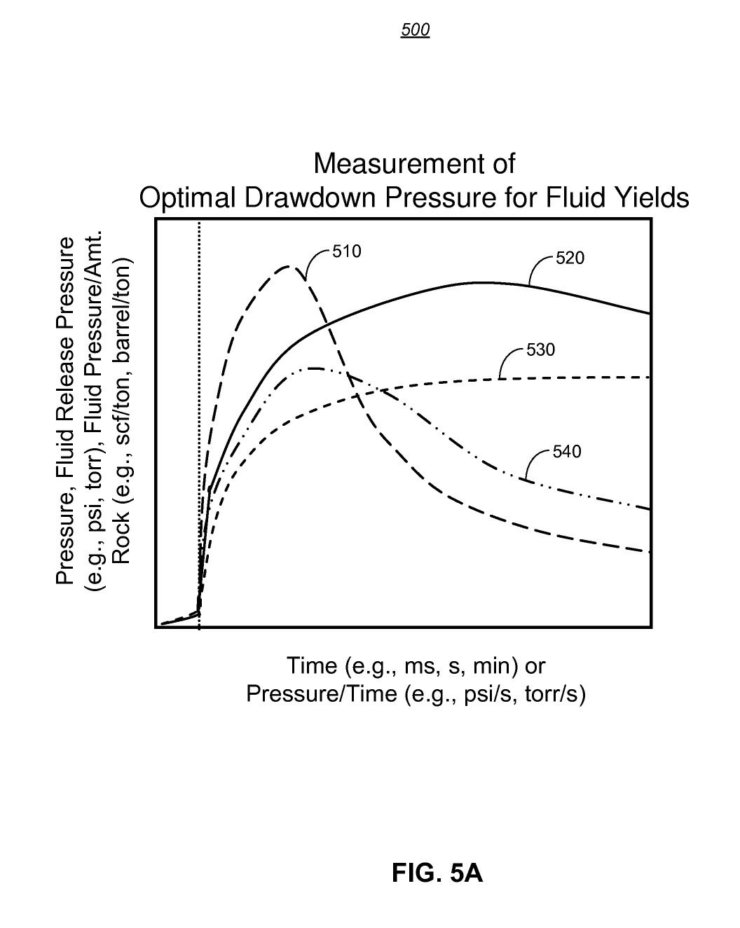

At step 422, system computer 150 may determine whether steps 402-420 should be repeated using different initial pressure values at step 410. In one implementation, a predetermined number of pressure initial values may be specified for method 400. As such, steps 402-420 may be repeated using other geological samples 110 acquired from the same depth as the first geological sample 110 for the predetermined initial pressure value at step 410. For instance, graph 500 FIG. 5A illustrates sample pressure measurements acquired after four iterations of steps 402-420. Graph 500 illustrates the pressure inside chamber 120 (i.e., vertical axis) as a function of time (i.e., horizontal axis). As shown in FIG. 5A, the fluid content over time curve (i.e., pressure change over time data) acquired after each iteration of steps 402-420 vary significantly. (See curves 510-540).

At step 425, system computer 150 may identify the optimum drawdown pressure value based on the pressure change over time data acquired after each iteration of steps 402-420. In one implementation, system computer 150 may compare the pressure change over time data acquired for each iteration and analyze which pressure change over time curve has the most area underneath its curve. The area underneath each pressure change over time data curve may represent the amount of fluid released by geological sample 110. The pressure of chamber 120 that corresponds to the pressure change over time data curve that has the most area underneath its curve may be the optimum drawdown pressure for geological sample 110.

Referring back to FIG. 5A, curve 520 may include the most area underneath its curve. As such, the pressure of chamber 120 that corresponds to curve 520 may be the optimum drawdown pressure for geological sample 110. Using the information gathered during the preliminary analysis performed at step 402, system computer 150 may scale up the optimum drawdown pressure for geological sample 110 to determine the optimum drawdown pressure for the subterranean area of the earth that corresponds to where geological sample 110 was acquired.

FIG. 4B illustrates also illustrates a flow diagram of a method 450 for estimating an optimum drawdown pressure for extracting a fluid from a subterranean area of the earth in accordance with implementations of various technologies and techniques described herein. In particular, method 450 may be used to obtain the optimum drawdown pressure by crushing a single geological sample in a chamber while altering the pressure inside the chamber and monitoring the pressure change in the chamber due to the crushing.

Method 450 may be characterized as a variable pressure (i.e., variable or multiple pressure conditions), multiple crushing and single subterranean depth sample analysis. Method 450 may also be used to perform a variable pressure, multiple crushing and multiple subterranean depth samples analysis. It should be understood that while the operational flow diagram indicates a particular order of execution of the operations, in some implementations, certain portions of the operations might be executed in a different order. In one implementation, method 450 may be performed by system computer 150, as described above in FIG. 1. The following description of method 450 is made with reference to fluid release system 100 of FIG. 1.

At step 452, preliminary analysis may be performed on geological sample 110. In one implementation, preliminary analysis may include determining the weight, the density, the mass and similar properties of geological sample 110. The preliminary analysis may be performed by direct measurement or by calculation. The information gathered from the preliminary analysis may be stored in a memory device on system computer 150.

At step 455, geological sample 110 may be placed in chamber 120. Geological sample 110 may be acquired from a particular depth (e.g., depth i) in a subterranean area of the earth. At step 460, system computer 150 may begin monitoring the pressure inside chamber 120. The pressure may be monitored using sensors 130 (e.g., pressure sensors) such as a transducer, a pressure gauge, a bourdon tube and the like. System computer 150 may receive pressure measurements from sensors 130 and may store the measurements with reference to the time at which they were acquired in a memory device. Using the pressure measurements, system computer 150 may track the initial pressure of chamber 120 prior to geological sample 110 being crushed at step 465.

In addition to monitoring the pressure change over time, system computer 150 may also measure various environmental factors of chamber 120 such as the temperature. The additional environmental data may be used to assist in determining the optimal drawdown pressure, as described in step 470 below. In one implementation, the temperature inside chamber 120 may be controlled using a temperature control device. The temperature control device may maintain an iso-thermal environment inside chamber 120 such that temperature changes that may occur inside chamber 120 may not affect the pressure values inside chamber 120.

At step 465, system computer 150 may simultaneously send a command to crushing device 140 to crush geological sample 110 while inside chamber 120 and to pressure control device 145 to alter the pressure inside chamber 120. In one implementation, system computer may send these two commands multiple times after a predetermined amount of time has expired. After receiving the command from system computer 150, crushing device 140 may crush geological sample 110 such that the volume of each geological sample 110 may be reduced at least 3-6%. By crushing geological sample 110, the fluid stored therein may be released (e.g., via desorption). The released fluid may then alter the pressure inside chamber 120.

Referring back to step 460, system computer 150 may continuously monitor the pressure inside each chamber 120 prior to each crushing and each pressure modification, concurrently while crushing geological sample 110, concurrently while modifying the pressure inside chamber 120 and after geological sample 110 has been crushed. As such, system computer 150 may monitor the multiple pressure change over time data at varying pressure values between each crush. In this manner, the pressure changes due to the crushing may be evaluated for multiple initial pressure values at the same time using the same chamber. At step 470, system computer 150 may identify the optimum drawdown pressure value for geological sample 110 based on the area underneath each of the multiple pressure change over time data acquired by sensors 130. Using the information gathered during the preliminary analysis performed at step 452, system computer 150 may scale up the optimum drawdown pressure for geological sample 110 to determine the optimum drawdown pressure for the subterranean area of the earth that corresponds to where geological sample 110 was acquired.

In one implementation, both methods 400 and 450 may be performed repeatedly for various geological samples acquired from various depths of the earth. In this manner, system computer 150 may determine the optimum drawdown pressure for efficient fluid extraction from various depths of the earth. Using the optimum drawdown pressures from various depths of the earth, system computer 150 may determine an optimum drawdown pressure distribution for a well or a borehole at various depths of the earth. The optimum drawdown pressure distribution may then be used to identify drilled zones that would respond optimally under different drawdown pressures. In one implementation, the drilled zones may be identified by analyzing the drawdown pressure distribution for a given well and identifying a portion of the drawdown pressure distribution that has similar optimum drawdown pressures. After identifying the drilled zones, engineering guidelines may be generated for producing the fluids from each drilled zone based on the optimum pressure distribution for the drilled zone.

Using the optimum drawdown pressures, system computer 150 may calculate commercial values or high-accuracy reserve values for the subterranean region of the earth that corresponds to each geological sample. The high-accuracy reserve value may be determined by computing for the product of the optimum fluid yield (obtained using the optimum drawdown pressure) and the area of the fluid release. FIG. 5B provides an example of various commercial value curves and optimal fluid reserve curves for various depths of a subterranean area of the earth that may be obtained based on the optimum drawdown pressures determined in methods 400 and 450.

### Optimum Drawdown Pressure—Commercial Analysis

FIG. 5B illustrates commercial analysis graphs 550 for extracting fluids in accordance with implementations of various technologies and techniques described herein. Commercial analysis may be performed using engineering data, such as optimum fluids-in-place data. Optimum fluids-in-place data may be determined by determining the fluids-in-place data at various depths of the subterranean area in the earth (determined using method 200) and the optimum drawdown pressures at each depth (determined using methods 400 and 450). Graph 557 illustrates fluids-in-place (i.e., horizontal axis) as a function of subsurface depth (i.e., vertical axis). The optimum fluids-in-place data for various geological samples at various depths are represented by curve 555 in FIG. 5B.

In one implementation, since optimum fluids-in-place data vary with geological sample, (i.e., with depth), different engineering zones for fluid extraction may be identified based on groupings of the optimum fluids-in-place data with respect to depth. After identifying different engineering zones for fluid extraction, system computer 150 may determine an optimum drawdown pressure for extracting fluids for each different engineering zone.

Further, the optimum fluids-in-place data may be used to determine the short term, medium term, long term and cumulative commercial values that corresponds to extracting the fluids form the subterranean area of the earth. For instance, when comparing rate of fluid yield among different engineering zones, certain engineering zones will yield fluids faster than others; some zones will have long-term contributions but not short-term, etc. As such, system computer 150 may use commercial valuation processed to determine a value of produced fluids for various time durations (e.g., short, medium and long-term—say <6 mo., 6-18 mo., 18 mo.+). Graph 577 illustrates the commercial value (i.e., horizontal axis) of the fluids in the subsurface as a function of subsurface depth (i.e., vertical axis). For instance, graph 577 illustrates the short term, medium term, long term and cumulative commercial values with curve 560, curve 565, curve 570 and curve 575, respectively.

Additionally, the fluids-in-place data may be used to determine optimal fluid reserves. As mentioned above, reserve values may be determined by finding the product of the optimum fluid yield (obtained using the optimum drawdown pressure) and the area of the fluid release. Graph 587 illustrates the optimal fluid reserves (i.e., horizontal axis) in the subsurface as a function of subsurface depth (i.e., vertical axis). For example, graph 587 illustrates the optimal recoverable liquid reserves and the optimal recoverable gas reserves available in the subterranean area of the earth with curve 580 and curve 585, respectively.

### Determining Optimum Drawdown Pressure for Drilled Zones

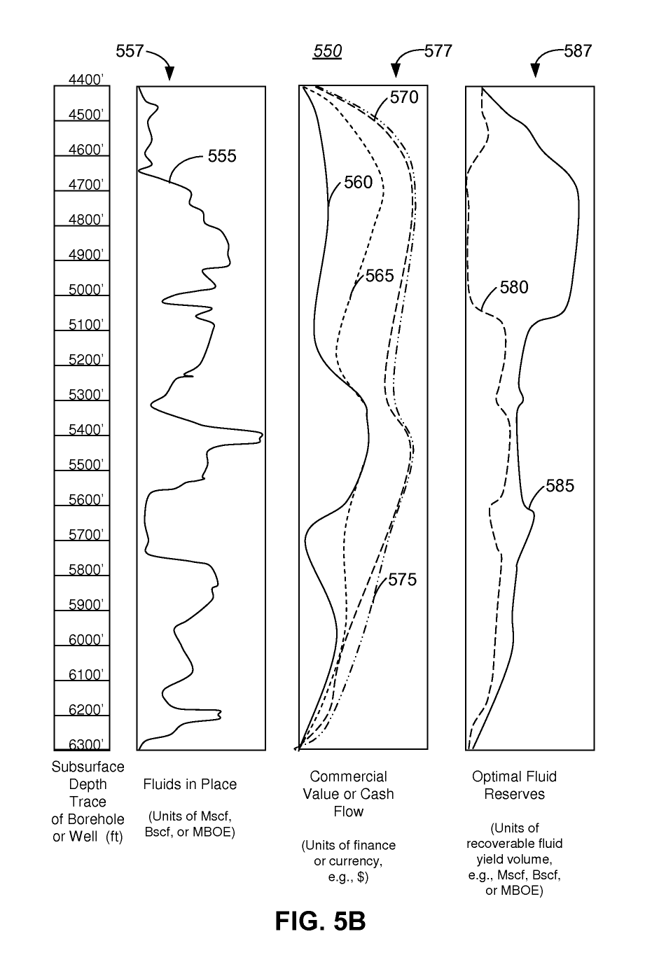

FIG. 6 illustrates a flow diagram of method 600 for estimating an optimum drawdown pressure for extracting a fluid volume from a drilled zone in a subterranean area of the earth in accordance with implementations of various technologies and techniques described herein. In particular, method 600 may be used to obtain the optimum drawdown pressure for a drilled zone by crushing geological samples acquired from the drilled zone in controlled pressure environments and monitoring the pressure change in each pressure environment due to the crushing.

It should be understood that while the operational flow diagram indicates a particular order of execution of the operations, in some implementations, certain portions of the operations might be executed in a different order. In one implementation, method 600 may be performed by system computer 150, as described above in FIG. 1. The following description of method 600 is made with reference to fluid release system 100 of FIG. 1.

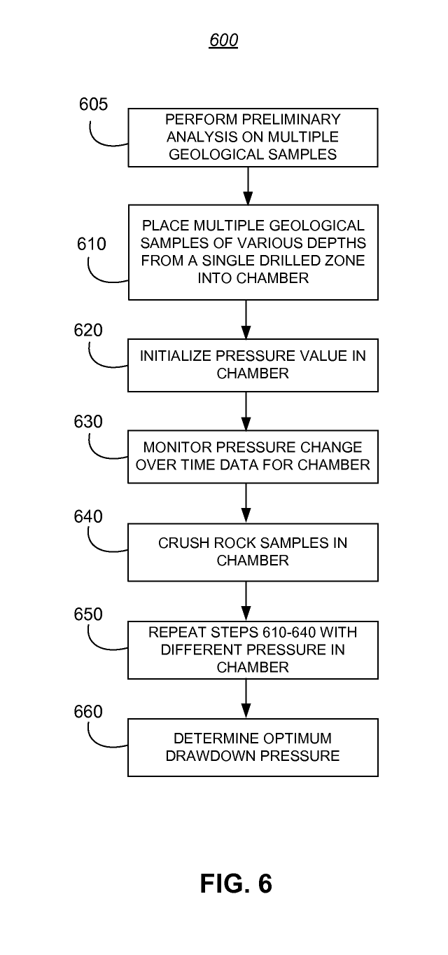

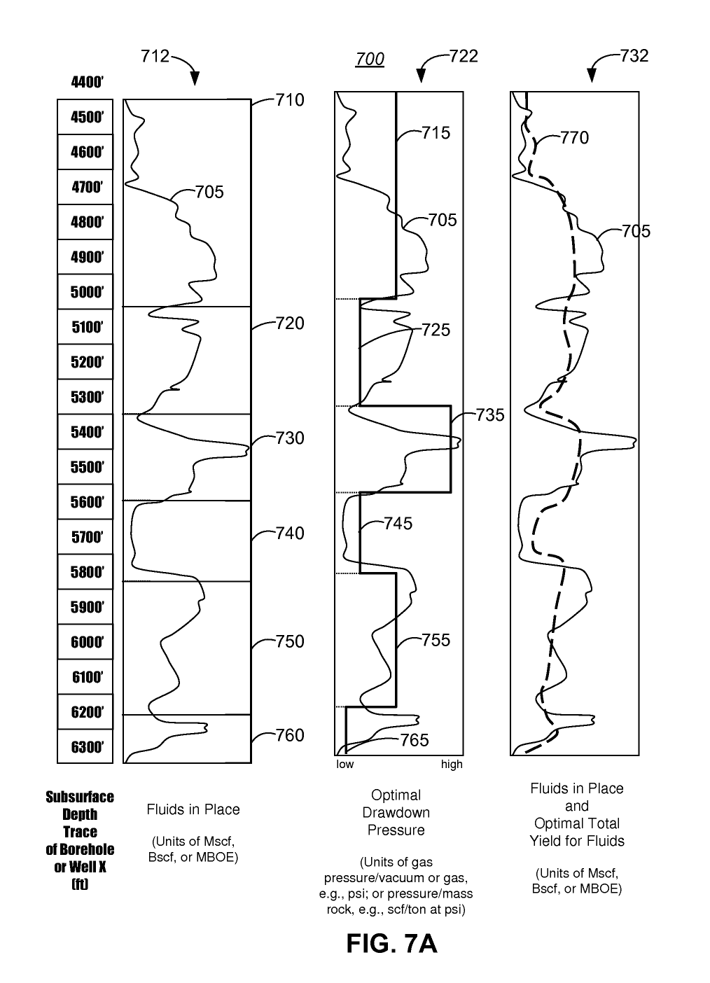

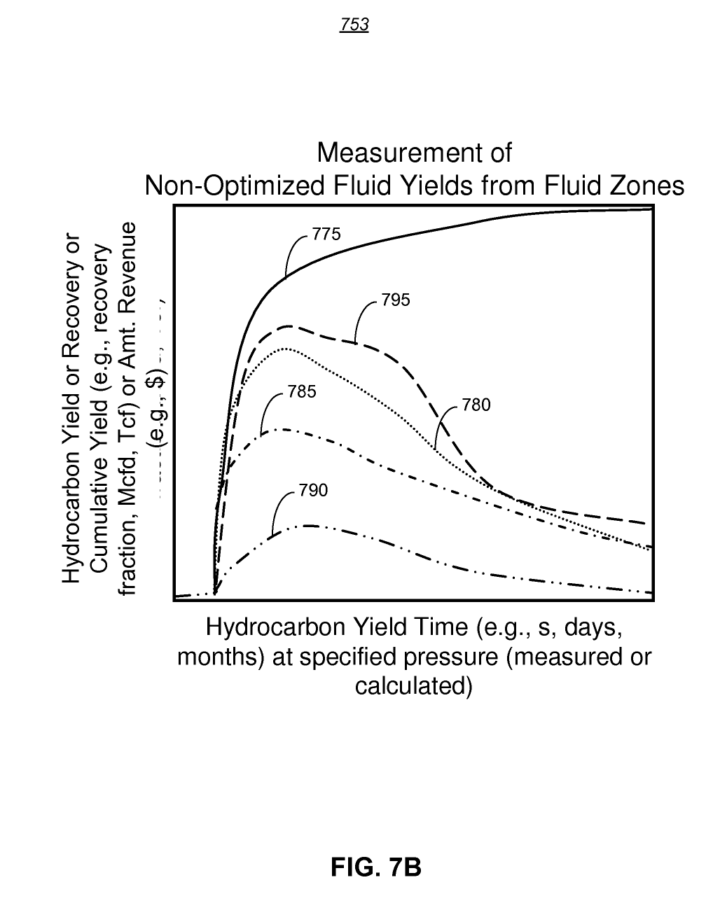

A drilled zone may refer to a subterranean area of the earth that is generally made up of the same type of geological material or of a similar type of geologic material (e.g., similar stratigraphic facies). A drilled zone may also refer to a subterranean area of the earth that is rich in fluids. FIG. 7A illustrates a graph of six different drilled zones and the fluid desorption profile that corresponds to a subterranean area of the earth. When extracting hydrocarbons from a subterranean area of the earth, it may beneficial to extract the hydrocarbons from an entire drilled zone via perforations (or any other type of formation completions) throughout the entire drilled zone. As such, in order to yield the most hydrocarbons from an entire drilled zone, fluids may be extracted via the perforations at an optimum drawdown pressure.

At step 605, preliminary analysis may be performed on multiple geological samples 110 acquired from a particular drilled zone. In one implementation, preliminary analysis may include determining the weight, the density, the mass and similar properties of each geological sample 110. The preliminary analysis may be performed by direct measurement or by calculation. The information gathered from the preliminary analysis may be stored in a memory device on system computer 150.

At step 610, multiple geological samples 110 may be placed in chamber 120. In one implementation, the location of a drilled zone may be estimated based on a visual inspection of a vertical profile of fluid in place data. For instance, ten drill cuttings (i.e., geological sample 110) acquired at various depths throughout a single drilled zone (e.g., drilled zone 710 in FIG. 7A) may be placed into chamber 120.

At step 620, system computer 150 may send a command to pressure control device 145 to initialize a pressure inside chamber 120 to a predetermined pressure level. The predetermined pressure level may correspond to a pressure value that is used when extracting gases or liquids or other fluids from the drilled zone.

At step 630, system computer 150 may begin monitoring the pressure inside chamber 120 over time. The pressure may be monitored using sensors 130. System computer 150 may receive pressure measurements from sensors 130. Using the pressure measurements, system computer 150 may track the pressure change over time with respect to the time at which geological sample 110 may have been crushed. In addition to monitoring the pressure change over time, system computer 150 may also measure various environmental factors of chamber 120 such as the temperature. The additional environmental data may be used to assist in determining the optimal drawdown pressure, as described in step 660 below. In one implementation, the temperature inside chamber 120 may be controlled using a temperature control device. The temperature control device may maintain an iso-thermal environment inside chamber 120 such that temperature changes that may occur inside chamber 120 may not affect the pressure values inside chamber 120.

At step 640, system computer 150 may send a command to crushing device 140 to crush geological samples 110 while inside the pressure controlled chamber 120. Crushing device 140 may then commence crushing geological samples 110 such that the volume of geological samples 110 may be reduced at least 3-6%.

At step 650, system computer 150 may repeat steps 610-640 using a different set of geological samples 110 acquired from the same drilled zone. When repeating step 620, system computer 150 may alter the pressure inside chamber 120 to a different pressure value than from the previous iteration of method 600. Steps 610-640 may be repeated multiple times to identify the optimum drawdown pressure for the multiple geological samples 110 from the drilled zone. Each iteration of steps 610-640 may use a cleaned chamber 120 to prevent previous the geological sample's residue from interfering with the results.

At step 660, system computer 150 may identify the optimum drawdown pressure value for the multiple geological samples 110 from the drilled zone based on the pressure change over time data. In one implementation, system computer 150 may compare the pressure change over time data and analyze which pressure change over time curve has the most area underneath its curve. The area underneath each pressure change over time data curve may indicate the amount of fluid (e.g., gas) released by the multiple geological samples 110. The pressure that corresponds to the pressure change over time data curve that has the most area underneath its curve may be the statistical average or mean optimum drawdown pressure for the geological samples 110 from the drilled zone. Using the information gathered during the preliminary analysis performed at step 604, system computer 150 may scale up the optimum drawdown pressure for geological samples 110 to determine the optimum drawdown pressure for the drilled zone that corresponds to where geological samples 110 were acquired.

In one implementation, instead of repeating steps 610-640, at step 640, system computer 150 may send a command to crushing device 140 to crush multiple geological samples 110 multiple times. Each time crushing device 140 crushes geological samples 110, system computer 150 may also send a command to pressure control device 145 to change the initial pressure inside chamber 120. System computer 150 may then receive multiple pressure change over time data for the multiple geological samples 110 at different pressures. In this manner, numerous pressure values may be evaluated using the same geological samples 110.

After crushing geological sample 110 and changing the initial pressure inside chamber 120 multiple times, system computer 150 may identify the optimum drawdown pressure value for the multiple geological samples 110 from the drilled zone (i.e., step 660). Here, system computer 150 may compare the pressure change over time data in the time intervals between each crushing. System computer 150 may then determine which pressure change over time curve in each time interval has the most area underneath its curve with respect to the modified pressure. As mentioned above, the modified pressure value that corresponds to the time interval that has the pressure change over time data curve with the most area underneath its curve may be the statistical average or mean optimum drawdown pressure for the geological samples 110 from the drilled zone. Using the information gathered during the preliminary analysis performed at step 604, system computer 150 may scale up the optimum drawdown pressure for geological samples 110 to determine the optimum drawdown pressure for the drilled zone that corresponds to where geological samples 110 were acquired.

FIG. 7A illustrates optimum drawdown pressure analysis for six drilled zones in accordance with implementations of various technologies and techniques described herein. Graph 712 of FIG. 7A illustrates fluids-in-place (i.e., horizontal axis) as a function of subsurface depth (i.e., vertical axis). As indicated in graph 712, the subterranean area of the earth may include six drilled zones (i.e., drilled zone 710, drilled zone 720, drilled zone 730, drilled zone 740, drilled zone 750 and drilled zone 760). Each drilled zone may be composed of a different type of rock having different pore types. In one implementation, each drilled zone may be identified based on a visual inspection of fluids-in-place data (i.e., curve 705).

Referring back to method 600, at step 610, multiple geological samples 110 may be acquired throughout drilled zone 710, drilled zone 720 drilled zone 730, drilled zone 740, drilled zone 750 or drilled zone 760 to determine the optimum drawdown pressure for the corresponding drilled zone. Graph 722 of FIG. 7A illustrates optimum drawdown pressures (i.e., horizontal axis) as a function of subsurface depth (i.e., vertical axis). Graph 722 illustrates the optimum drawdown pressures (i.e., curve 715, 725, 735, 745, 755 and 765) for each drilled zone (i.e., drilled zone 710, 720, 730, 740, 750 and 760).

After determining the optimum drawdown pressure for each drilled zone, system computer may determine commercial data. For instance, graph 732 of FIG. 7A illustrates optimum total yields for fluids (i.e., horizontal axis) as a function of subsurface depth (i.e., vertical axis). As such, graph 732 includes an optimum fluid yield curve 770 which may represent commercial data that corresponds to the subterranean area of the earth.

FIG. 7B illustrates an example graph 753 of fluid yields using non-optimized drawdown pressures in accordance with implementations of various technologies and techniques described herein. Graph 753 of FIG. 7B illustrates a hydrocarbon recovery or cumulative yield (i.e., vertical axis) as a function of time (i.e., horizontal axis). Curve 790 indicates the hydrocarbon yield over time for drilled zone 710 when extracting the hydrocarbon using non-optimized drawdown pressures. Similarly, curve 785 indicates the hydrocarbon yield over time for drilled zone 720 when extracting the hydrocarbon using non-optimized drawdown pressures. Curve 780 indicates the combined hydrocarbon yield for drilled zone 710 and drilled zone 720. Curve 775 indicates the cumulative hydrocarbon yield for drilled zone 710 and drilled zone 720. Curve 795 indicates the cumulative cash flow profile associated with production of a fluid yield using non-optimized drawdown pressures.

FIG. 7C illustrates an example graph 758 of fluid yields using optimized drawdown pressures in accordance with implementations of various technologies and techniques described herein. Graph 758 of FIG. 7C illustrates a hydrocarbon recovery or cumulative yield (i.e., vertical axis) as a function of time (i.e., horizontal axis). Curve 793 indicates the hydrocarbon yield over time for drilled zone 710 when extracting the hydrocarbon using an optimized drawdown pressure for each drilled zone as determined by method 600. Similarly, curve 788 indicates the hydrocarbon yield over time for drilled zone 720 when extracting the hydrocarbon using an optimized drawdown pressure for each drilled zone as determined by method 600. Curve 783 indicates the combined hydrocarbon yield for drilled zone 710 and drilled zone 720 using optimized drawdown pressures for each drilled zone as determined by method 600. Curve 775 indicates the cumulative hydrocarbon yield for drilled zone 710 and drilled zone 720 using optimized drawdown pressures for each drilled zone as determined by method 600. Curve 798 indicates the cumulative cash flow profile for a fluid yield using optimized drawdown pressures.

When comparing cumulative hydrocarbon yield curve 775 of FIG. 7B with cumulative hydrocarbon yield curve 778 of FIG. 7C, it is apparent that using optimized drawdown pressures for each drilled zone will result in a significant increase in hydrocarbon yields. Similarly, when comparing cumulative cash flow profile curve 795 of FIG. 7B with cumulative cash flow profile curve 798 of FIG. 7C, it is apparent that using optimized drawdown pressures for each drilled zone will result in a significant increase in cash flow.

### Determining Fluid Habitat

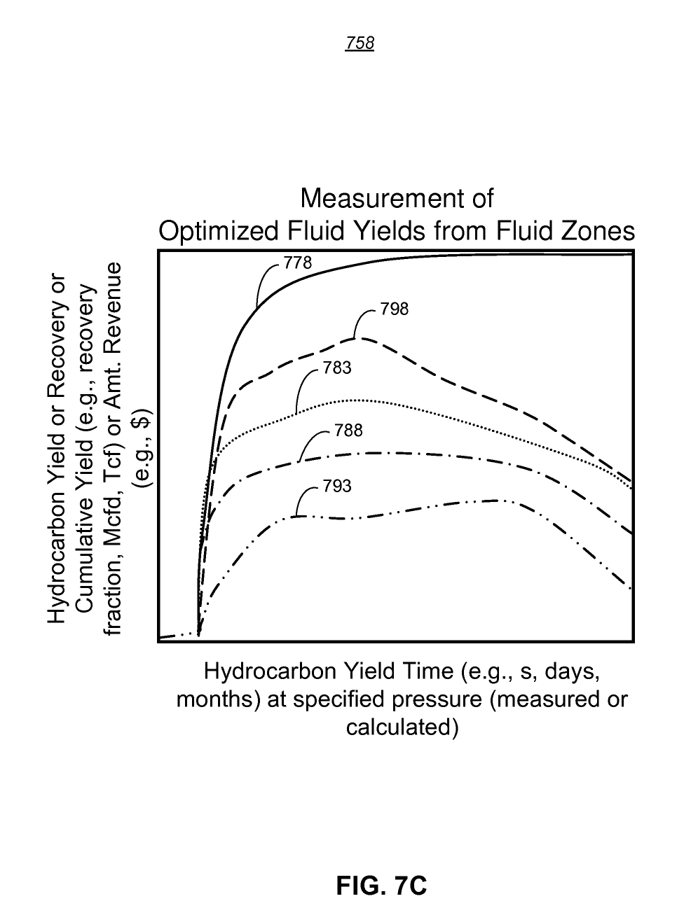

FIG. 8 illustrates a flow diagram of a method 800 for determining a fluid habitat of a geological sample from a surface or subterranean area of the earth in accordance with implementations of various technologies and techniques described herein. In particular, method 800 may be used to determine a fluid habitat of a subterranean area of the earth by crushing geological samples acquired from the subterranean area of the earth multiple times and observing the characteristics of a pressure change over time curve due to the multiple crushings.

It should be understood that while the operational flow diagram indicates a particular order of execution of the operations, in some implementations, certain portions of the operations might be executed in a different order. In one implementation, method 800 may be performed by system computer 150, as described above in FIG. 1. The following description of method 800 is made with reference to fluid release system 100 of FIG. 1.

A fluid habitat may describe any environment in which a fluid resides within a geological material. Fluid habitat may be affected by a rock type or a rock property of geological sample 110. A rock type may include the rock's mineralogy, grain size, distributions, geologic age, provenance and/or petrogenetic origin. Rock properties may include pore type, porosity, permeability, heterogeneity including presence of fractures or faults and their properties, geomechanical properties such as brittle behavior, elasticity, preferred orientations (e.g., geologic “fabrics”), stress/strain directional relationships, and basic physical properties such as density, etc. As mentioned above, fluid habitat may include open pore space, adsorbed, bound, entrapped and mineral surface (i.e., wetting effects).

At step 810, geological sample 110 may be placed in an individual chamber 120. At step 820, system computer 150 may initialize the pressure inside chamber 120 to a predetermined pressure value using pressure control device 145.

At step 830, system computer 150 may monitor the pressure inside each chamber 120 over time. The pressure may be monitored using sensors 130 (e.g., pressure sensors) such as a transducer, a pressure gauge, a bourdon tube and the like. System computer 150 may receive pressure measurements from sensors 130. Using the pressure measurements, system computer 150 may track the pressure change over time with respect to the time at which geological sample 110 may have been crushed.

At step 840, system computer 150 may send a command to crushing device 140 to crush geological samples 110 while inside the pressure controlled chamber 120 multiple times. In one implementation, crushing device 140 may crush geological samples 110 after a predetermined amount of time (e.g., one minute) has expired.

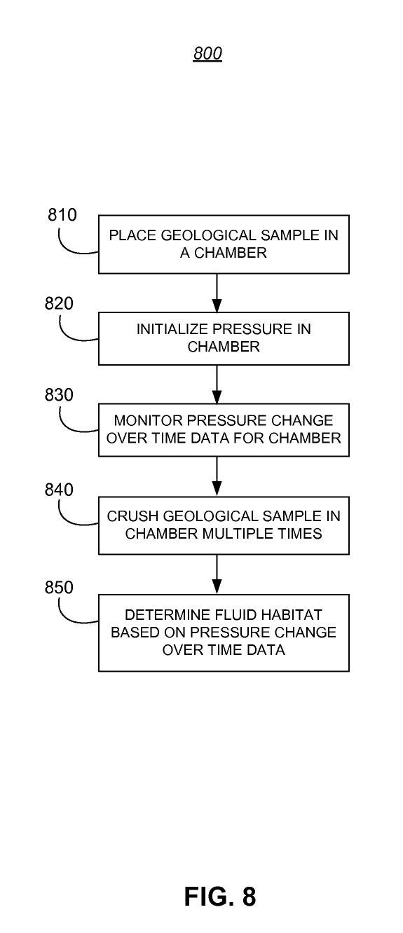

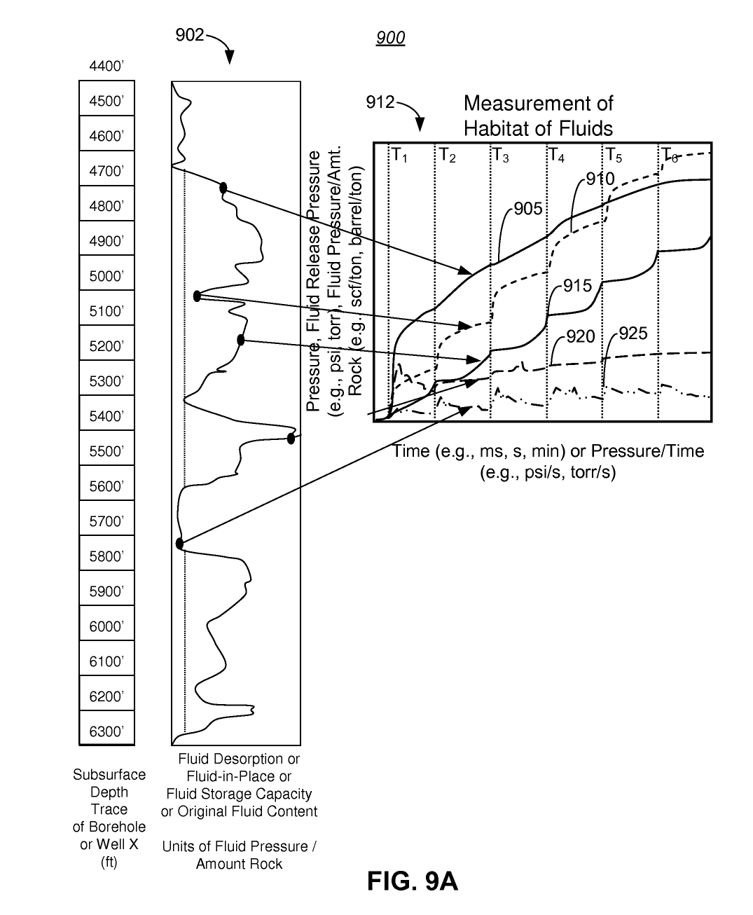

At step 850, system computer 150 may determine the fluid habitat of geological sample 110 based on the pressure change over time data. FIG. 9A illustrates a graph 912 of fluid content versus time for four geological samples that have been crushed six times. Graph 912 illustrates pressure (i.e., vertical axis) as a function of time (i.e., horizontal axis). Each curve (905-925) in graph 912 corresponds to a different geological sample obtained at different depths of a subterranean area of the earth as shown in FIG. 9A. Each geological sample 110 may be crushed at times T₁, T₂, T₃, T₄, T₅ and T₆. As seen in curves 905-925, each geological sample exhibits different pressure change over time data characteristics. The pressure change over time data after each crushing function may be used to identify the fluid habitat that corresponds to the geological sample. In one implementation, the fluid habitat for a particular geological sample may include a plurality of rock types or rock properties. The pressure change over time data may be used to identify the corresponding percentages of fluid habitat. Such percentages may be associated with rock types and/or rock properties, and therefore the distribution of fluid habitat may be used to identify (congruently) rock types or rock properties.

In one implementation, the identity of each fluid habitat may be based on a theoretical pressure change over time data. In this case, the observed pressure change over time data may be compared with a theoretical pressure change over time curve for various fluid habitats. The theoretical pressure change over time curve that matches the actual pressure change over data curve may be used to identify the fluid habitat of the geological sample. In another implementation, the identity of each fluid habitat may be determined using a database of pressure change over time data acquired at an earlier time with known fluid habitats. In this case, the observed pressure change over time data may be compared with each pressure change over time data in the database. If the observed pressure change over time data matches a pressure change over time data in the database, the fluid habitat that corresponds to the matching pressure change over time data in the database may be the fluid habitat of the geological sample.

FIG. 9B illustrates pore type distribution in a subterranean area of the earth in accordance with implementations of various technologies and techniques described herein. FIG. 9B includes graph 951 which illustrates a pore type fraction of a geological formation (i.e., horizontal axis) as a function of subsurface depth (i.e., vertical axis). As mentioned above, method 800 may identify the fluid habitat, such as pore types of geological sample 110. In one implementation, geological sample 110 may be composed of two or more pore types. The percentage of particular pore types that may be present in each geological sample 110 may be determined based on a pressure change over time data as described in method 800 above. The percentage of particular pore types that may be present in each geological sample 110 may be used to indicate the absolute pore type fractions within a subterranean area of the earth. FIG. 9B, for example, illustrates absolute pore type fractions throughout a subterranean depth of the earth. In one implementation, graph 951 may be determined by performing method 800 using multiple geological samples from various depths in the earth. Graph 951 includes absolute fractions of open pore type curve 955, sorbed pore type curve 960, fracture-related pore type curve 965 and fault-related pore type curve 970.

The percentage of particular pore types that may be present in each geological sample 110 may also be used to indicate the relative distribution of pore types within a subterranean area of the earth. FIG. 9B also illustrates relative distributions of pore types at various depths in the earth for various formations in graph 952, graph 953, graph 954 and graph 956. Graph 952, graph 953, graph 954 and graph 956 illustrates a relative pore type distribution (i.e., horizontal axis) as a function of subsurface depth (i.e., vertical axis) for different geological formations. The relative distribution of open pore type, sorbed pore type, fracture pore type and fault pore type are illustrated with curve 955, curve 960, curve 965 and curve 970, respectively.

### Determining Optimum Surface Area for Fluid Yield

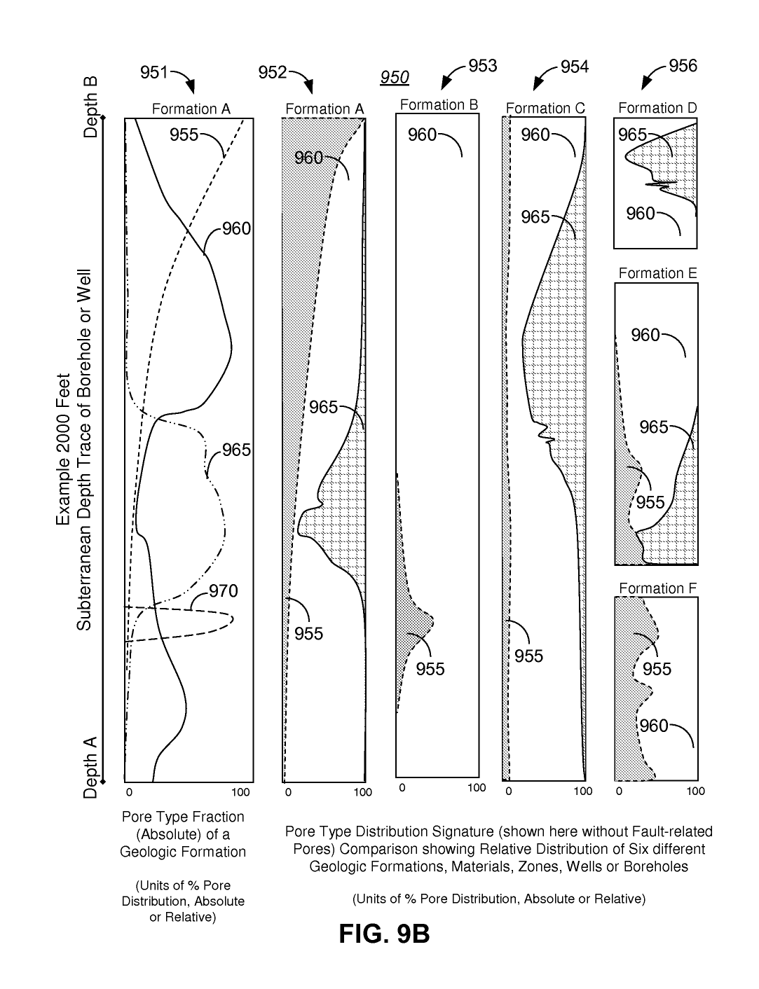

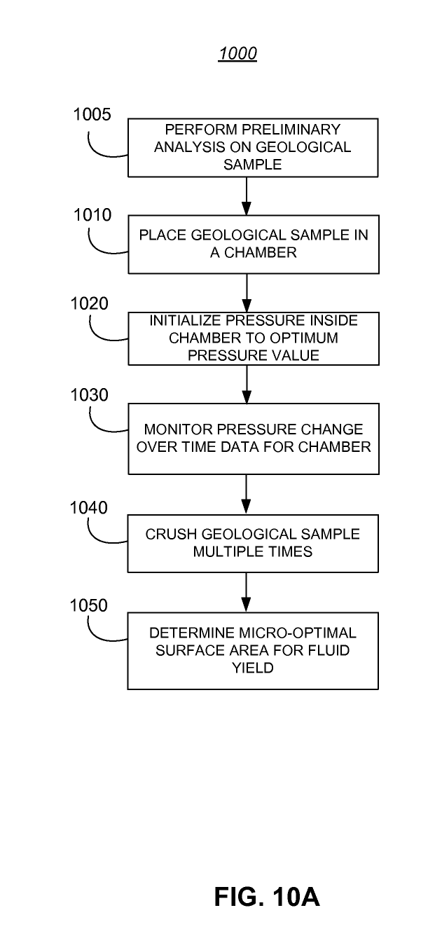

FIG. 10A illustrates a flow diagram of a method 1000 for determining optimal surface area for fluid yield using a static pressure in accordance with implementations of various technologies and techniques described herein. In particular, method 1000 may be used to obtain the optimum surface area of a geological sample for extracting fluids by crushing a geological sample multiple times and identifying the crushing interval that generated the maximum pressure increase. Because this measurement is made at a microscopic scale, it is termed micro-optimal surface area.

It should be understood that while the operational flow diagram indicates a particular order of execution of the operations, in some implementations, certain portions of the operations might be executed in a different order. In one implementation, method 1000 may be performed by system computer 150, as described above in FIG. 1. The following description of method 1000 is made with reference to fluid release system 100 of FIG. 1.

At step 1005, preliminary analysis may be performed on geological sample 110. In one implementation, preliminary analysis may include determining the weight, the density, the mass and similar properties of geological sample 110. The preliminary analysis may be performed by direct measurement or by calculation. The information gathered from the preliminary analysis may be stored in a memory device on system computer 150.

At step 1010, geological sample 110 may be placed in an individual chamber 120. At step 1020, system computer 150 may send a command to pressure control device 150 to set the pressure inside chamber 120 to an optimum drawdown pressure value. The optimum drawdown pressure value may be determined using method 400 or 450 described above.

At step 1030, system computer 150 may begin monitoring the pressure inside each chamber 120 over time. The pressure may be monitored using sensors 130 (e.g., pressure sensors) such as a transducer, a pressure gauge, a bourdon tube and the like. System computer 150 may receive pressure measurements from sensors 130 and may store the measurements with reference to the time at which they were acquired in a memory device. Using the pressure measurements, system computer 150 may track the initial pressure of chamber 120 prior to geological sample 110 being crushed at step 1040.

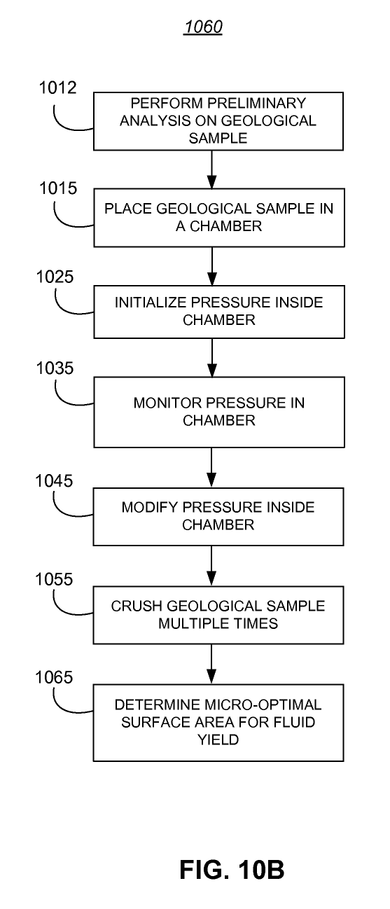

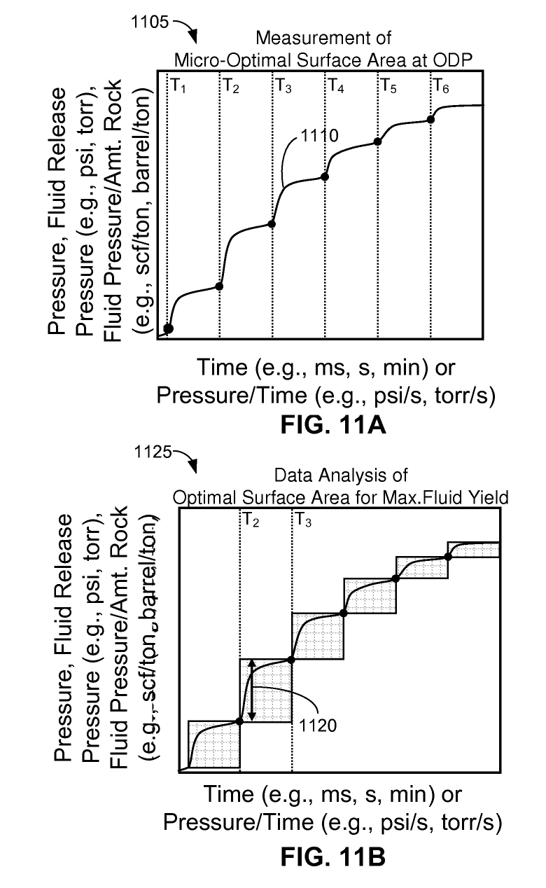

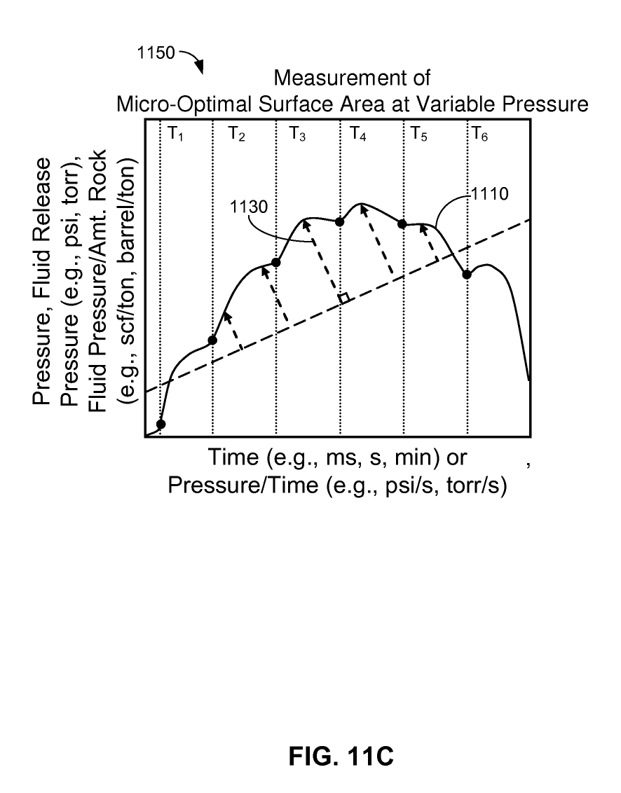

At step 1040, system computer 150 may send a command to crushing device 140 to crush geological sample 110 while inside the pressure controlled chamber 120 multiple times. In one implementation, crushing device 140 may successively crush geological samples 110 after a predetermined amount of time (e.g., one minute) has expired. Graph 1105 of FIG. 11A illustrates pressure (i.e., vertical axis) as a function of time (i.e., horizontal axis). Graph 1105 provides an example pressure curve 1110 that indicates the pressure inside chamber 120 after geological sample 110 is crushed at times T₁, T₂, T₃, T₄, T₅ and T₆.

At step 1050, system computer 150 may determine the micro-optimal surface area for yield based on the pressure change over time data. The micro-optimal surface area (MOSA) for yield may indicate the surface area of the crushed geological sample 110 that corresponds to the optimal release of fluids from geological sample 110. In one implementation, system computer 150 may analyze the change in pressure values between each crush (i.e., in each crush interval) to identify the optimal release of fluids. Graph 1125 of FIG. 11B also illustrates pressure (i.e., vertical axis) as a function of time (i.e., horizontal axis). Graph 1125 illustrates the pressure change between each crushing period. As seen in graph 1125, pressure change 1120 corresponds to the largest pressure increase. In this manner, system computer 150 may determine that the surface area of the geological sample 110 in the crush interval between time T₂ and time T₃ is the micro-optimal surface area for fluid yield.

In one implementation, the micro-optimal surface area for yield may be scaled up to match the rock from which the geological sample 110 was obtained to determine a field-optimal surface area (FOSA) for yield using the data acquired from the preliminary analysis at step 1005. The micro-optimal surface area for yield may be scaled up using a linear multiplication function. The field-optimal surface area for yield may be used to determine the degree to which the rock formations in the subterranean area of the earth should be fractured, crushed or otherwise modified by engineering activities in order to yield the maximum amount of fluids. Therefore, the micro-optimal surface area for yield may be used as guidelines for optimizing formation completions, fracking or any other activity associated with increasing surface area of geologic materials to improve fluid yield.

FIG. 10B illustrates a flow diagram of a method 1060 for determining a micro-optimal surface area for fluid yield using a dynamic pressure in accordance with implementations of various technologies and techniques described herein. In particular, method 1060 may be used to obtain the optimum surface area of a geological sample for extracting fluids by crushing a geological sample multiple times in a controlled pressure environment and identifying the crushing interval that generated the maximum pressure increase with respect to the controlled pressure.

It should be understood that while the operational flow diagram indicates a particular order of execution of the operations, in some implementations, certain portions of the operations might be executed in a different order. In one implementation, method 1060 may be performed by system computer 150, as described above in FIG. 1. The following description of method 1060 is made with reference to fluid release system 100 of FIG. 1.

At step 1012, preliminary analysis may be performed on geological sample 110. In one implementation, preliminary analysis may include determining the weight, the density, the mass and similar properties of geological sample 110. The preliminary analysis may be performed by direct measurement or by calculation. The information gathered from the preliminary analysis may be stored in a memory device on system computer 150.

At step 1015, geological sample 110 may be placed in an individual chamber 120. At step 1025, system computer 150 may send a command to pressure control device 150 to set the pressure inside chamber 120 to an initial pressure value.

At step 1035, system computer 150 may begin monitoring the pressure inside each chamber 120 over time. The pressure may be monitored using sensors 130 (e.g., pressure sensors) such as a transducer, a pressure gauge, a bourdon tube and the like. System computer 150 may receive pressure measurements from sensors 130 and may store the measurements with reference to the time at which they were acquired in a memory device. Using the pressure measurements, system computer 150 may track the pressure inside chamber 120.

At step 1045, system computer 150 may send a command to pressure control device 150 to modify the pressure inside chamber 120 at a specific rate of pressure change or a variable rate of pressure change. In one implementation, the pressure inside chamber 120 may be decreased at a constant rate using a vacuum.

At step 1055, system computer 150 may send a command to crushing device 140 to crush geological sample 110 while inside the pressure controlled chamber 120 multiple times. In one implementation, crushing device 140 may successively crush geological samples 110 after a predetermined amount of time (e.g., one minute) has expired. Graph 1150 of FIG. 11C illustrates pressure (i.e., vertical axis) as a function of time (i.e., horizontal axis). Graph 1150 provides an example pressure curve 1110 that indicates the pressure inside chamber 120 after geological sample 110 is crushed at times T₁, T₂, T₃, T₄, T₅ and T₆. In addition to pressure curve 1110, graph 1150 provides an example of the pressure increase inside chamber 120 due to pressure control device 150 as described in step 1045.

At step 1060, system computer 150 may determine the micro-optimal surface area for fluid yield based on the pressure change over time data with respect to the constant pressure change due to pressure control device 145. The micro-optimal surface area (MOSA) for yield may indicate the surface area of the crushed geological sample 110 that corresponds to the optimal release of fluids from geological sample 110. In one implementation, system computer 150 may analyze the change in pressure values between each crush (i.e., in each crush interval) to identify the optimal release of fluids. Graph 1150 illustrates the pressure change between each crushing period. As seen in graph 1150, pressure change 1130 corresponds to the largest pressure increase for any of the crush intervals. In this manner, system computer 150 may determine that the surface area of the geological sample 110 in the crush interval between time T₃ and time T₄ is the micro-optimal surface area for yield.

In one implementation, the micro-optimal surface area for yield may be scaled up to match the rock from which the geological sample 110 was obtained to determine a field-optimal surface area (FOSA) for yield of fluids using the data acquired from the preliminary analysis at step 1005. The micro-optimal surface area for yield may be scaled up using a linear multiplication function. The field-optimal surface area for yield may be used to determine the degree to which the rock formations in the subterranean area of the earth should be fractured, crushed to yield the maximum amount of fluids. Therefore, the micro-optimal surface area for yield may be used as guidelines for formation completions, fracking or any other activity associated with increasing surface area of geologic materials to improve fluid yield.

### Identifying Prospective Fluid Yield Areas

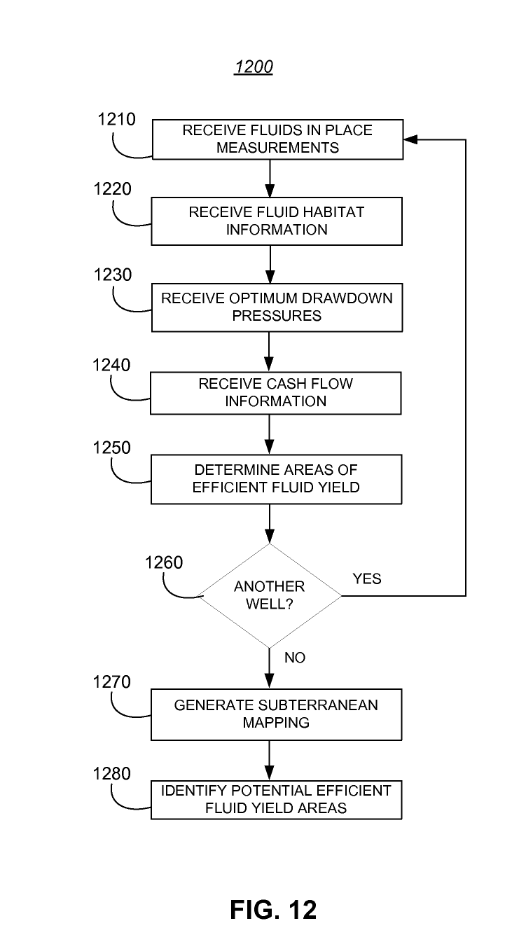

FIG. 12 illustrates a flow diagram of a method 1200 for identifying prospective fluid-containing areas of subterranean earth or for identifying subterranean areas of the earth that have efficient or desired fluid yields in accordance with implementations of various technologies and techniques described herein. In particular, method 1200 may be used to identify subterranean areas of the earth that may have efficient fluid yields by analyzing the information generated using the methods (i.e., method 200, 400, 450, 600, 800, 1000, 1060) described above.

It should be understood that while the operational flow diagram indicates a particular order of execution of the operations, in some implementations, certain portions of the operations might be executed in a different order. In one implementation, method 1200 may be performed by system computer 150, as described above in FIG. 1. The following description of method 1200 is made with reference to fluid desorption system 100 of FIG. 1.

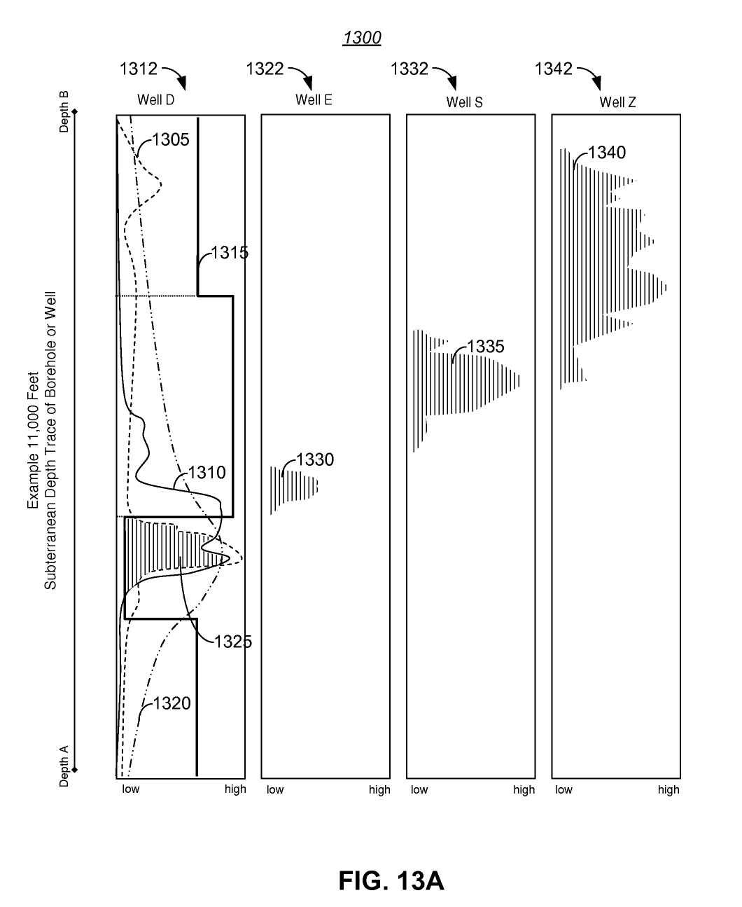

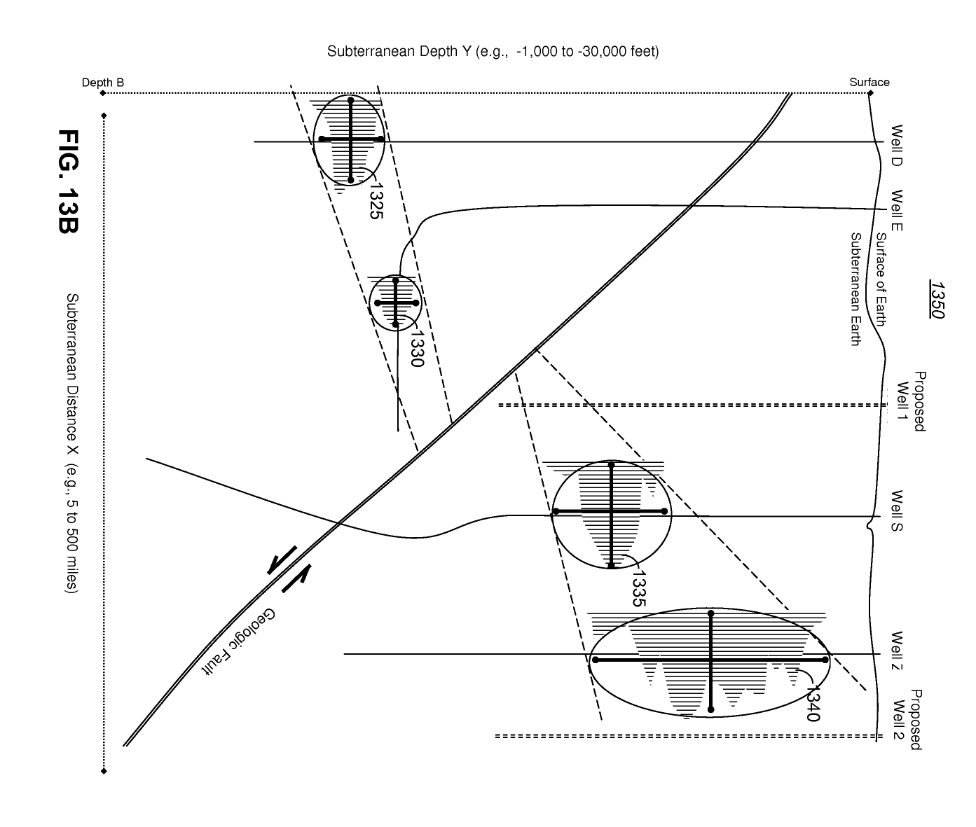

At step 1210, system computer 150 may receive fluids-in-place measurements for a well or borehole in a subterranean area of the earth. FIG. 13A includes graph 1312, graph 1322, graph 1332 and graph 1342. Each graph in FIG. 13A illustrates fluids-in-place measurements, pressure, cash flow and fracture content (i.e., horizontal axis) as a function of subterranean depth (i.e., vertical axis). For instance, graph 1312 provides an example of fluids-in-place measurements for Well D with curve 1305. Curve 1305 illustrates a characteristic curve for a fluid of intermediate gas and liquid characteristics (e.g., gas condensate-rich) for various depths in Well D. Curve 1305 may be determined using method 200 described above.

At step 1220, system computer 150 may receive fluid habitat information for a well or borehole in a subterranean area of the earth. For instance, system computer 150 may receive information indicating the distribution of fractures within the well. Graph 1312 provides an example of where fracture fluid habitats exist for Well D with curve 1310. Curve 1310 may be determined using method 800 described above.

At step 1230, system computer 150 may receive optimum drawdown pressures for each drilled zone of a well or borehole in a subterranean area of the earth. In one implementation, the zone of lowest optimal drawdown pressure may best fit with an engineering program for fluid extraction (e.g., based on capacity of engineering well and related facilities). Graph 1312 provides an example of the optimum drawdown pressures for four drilled zones in Well D with curve 1315. Curve 1315 for drilled zones may be determined using method 600 described above.

At step 1240, system computer 150 may receive cash flow information for various depths of a well or a borehole in a subterranean area of the earth. In one implementation, the cash flow information may indicate the greatest medium-term cash flow for various depths of the well. Graph 1312 provides an example of the greatest medium-term cash flow that may be available in Well D with curve 1320.

At step 1250, system computer 150 may determine an area in the well or borehole that may have efficient fluid yields based on the fluids-in-place measurements, fluid habitat information, optimum drawdown pressures and cash flow information. In one implementation, system computer 150 may identify a volume in the well where the fluids-in-place measurements, fluid habitat information, optimum drawdown pressures and cash flow information intersect such that an efficient fluid yield may be obtained. An efficient fluid yield may include the maximum amount of fluid yields that may be obtained while using the least amount of resources and gaining the most amount of cash flow (i.e., most economical zone of fluid recovery). Graph 1312 provides an example of where the most economical zone of fluid recover may exist in Well D with fluid recovery area 1325. As shown in FIG. 13A, fluid recovery area 1325 indicates the area in the well where a fluid of intermediate gas and liquid characteristics (curve 1305), fracture curve (curve 1310), optimum drawdown pressure (curve 1315) and medium-term cash flow (curve 1320) intersect such that the most economical amount of fluids may yield during extraction. Here, the economic fluid recovery analysis may be based on identifying where the most amounts of fluids may be extracted to obtain the highest medium-term cash flow values using the least drawdown pressure. In addition to these three variables, the economic fluid recovery analysis may also locate where the three above mentioned variables correspond with an area of the earth that includes a fluid habitat of mostly fractures because fluids may yield more easily through fractures.

Although method 1200 has been described using fluids-in-place measurements, fluid habitat information, optimum drawdown pressures for each drilled zone, and cash flow information, it should be noted that in other implementations system computer 150 may identify an area in the well or borehole that may have efficient fluid yields using any combination of the inputs described in steps 1210-1240. For instance, system computer 150 may identify an area in the well or borehole that may have efficient fluid yields using just the fluids-in-place measurements received at step 1210.

At step 1260, system computer 150 may repeat steps 1210-1250 for another well, borehole or any other source of geologic samples or related information to determine areas of efficient fluid yields may exist. For instance, FIG. 13A illustrates fluid recovery area 1330, fluid recovery area 1335 and fluid recovery area 1340 for Well E, Well S and Well Z that may have been identified using steps 1210-1250 above.

If system computer 150 does not have information for any other wells, system computer 150 may proceed to step 1270. At step 1270, system computer 150 may generate a subterranean mapping of the earth that includes areas of efficient fluid yields for each well. FIG. 13B illustrates a subterranean cross-section 1350 showing subterranean mapping of fluid recovery area 1325, fluid recovery area 1330, fluid recovery area 1335 and fluid recovery area 1340 with respect to its subterranean depths, subterranean distances, trajectories and a geological fault. Subterranean cross-section 1350 illustrates a subterranean depth (i.e., vertical axis) as a function of horizontal subterranean distance (i.e., horizontal axis).

At step 1280, system computer 1280 may analyze the subterranean mapping generated at step 1270 and identify potential efficient fluid yield areas. System computer 150 may analyze the trajectory of the efficient fluid yield areas from the geological fault in the subterranean mapping illustrated in FIG. 13B to determine where another efficient fluid yield area may be located. For instance, system computer 150 may analyze the subterranean mapping illustrated in FIG. 13B and observe that the size of the efficient fluid yield areas increase as the distance from the geological fault increases. As such, system computer 150 may be able to estimate the size of the potential fluid yield areas based on the known increases between each adjacent efficient fluid yield area. By performing the analysis described above, system computer 150 may determine that proposed Well 2 of FIG. 13B may be more likely to have an efficient fluid yield area as opposed to proposed Well 1 due to the trajectory of the known fluid yield areas and the size trends of the known fluid yield areas.

While the foregoing is directed to implementations of various technologies described herein, other and further implementations may be devised without departing from the basic scope thereof, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for estimating a fluid volume in a subterranean area of the earth, comprising:
(a) performing a preliminary analysis on a first geological sample;
(b) placing the first geological sample inside a chamber;
(c) monitoring pressure change over time data inside the chamber;
(d) crushing the first geological sample; and
(e) estimating the fluid volume based on the pressure change over time data and the preliminary analysis.

2. The method of claim 1, wherein the preliminary analysis comprises determining a weight, a density, or a mass of the first geological sample.

3. The method of claim 1, wherein the first geological sample comprises a rock, a fragment, a drill cutting or combinations thereof.

4. The method of claim 1, wherein the first geological sample was acquired from the surface of the earth.

5. The method of claim 1, wherein the first geological sample is pumped from a well located at a drill site.

6. The method of claim 1, wherein the chamber is sealed and maintains a predetermined pressure or a predetermined vacuum.

7. The method of claim 1, wherein the first geological sample is crushed using one or more cutting techniques, chopping techniques, pulverizing techniques, impact techniques, sonic vibration techniques or combinations thereof.

8. The method of claim 1, wherein the first geological sample is crushed at a continuous rate.

9. The method of claim 1, wherein crushing the first geological sample comprises reducing the volume of the geological sample by at least 3%-6%.

10. The method of claim 1, wherein crushing the first geological sample comprises reducing the volume of the geological sample by at least 33%.

11. The method of claim 1, wherein the pressure change over time data is monitored using one or more pressure sensors.

12. The method of claim 11, wherein the pressure sensors comprise one or more transducers, one or more pressure gauges, one or more bourdon tubes or combinations thereof.

13. The method of claim 1, wherein the pressure change over time data is monitored for less than one minute.

14. The method of claim 1, wherein estimating the fluid volume comprises:
scaling the pressure change over time data using the preliminary analysis; and
determining a fluid desorption content of the subterranean area of the earth that corresponds to the first geological sample based on the scaled pressure change over time data.

15. The method of claim 14, wherein scaling the pressure change data comprises applying a linear scaling factor to the pressure change over time data.

16. The method of claim 14, wherein the pressure change over time data is scaled to a pressure change over time data for fluid release of a region of the subterranean area of the earth over time.

17. The method of claim 14, further comprising removing noise from the pressure change over time data prior to scaling the pressure change over time data.

18. The method of claim 1, further comprising determining engineering data that corresponds to the fluid volume based on the pressure change over time data and the preliminary analysis.

19. The method of claim 18, wherein the engineering data comprises:
an amount of fluids in the fluid volume;
one or more physical characteristics of the fluids in the fluid volume;
a distribution of the fluids in the fluid volume;
one or more yields of the fluids in the fluid volume;
one or more reserves of the fluids in the fluid volume; or
combinations thereof.

20. The method of claim 1, further comprising determining commercial data that corresponds to fluids in the fluid volume based on the pressure change over time data and the preliminary analysis.

21. The method of claim 20, wherein the commercial data comprise:
one or more valuations of the fluids in the fluid volume;
a cash flow analysis for the fluids in the fluid volume; or
combinations thereof.

22. The method of claim 1, further comprising determining geological data that corresponds to fluids in the fluid volume based on the pressure change over time data and the preliminary analysis.

23. The method of claim 22, wherein the geological data comprise:
a distribution of the fluids in the fluid volume;
a delineation of an amount of the fluids in the fluid volume;
a fluid type of the fluids in the fluid volume;
a fluid habitat of the fluids in the fluid volume; or
combinations thereof.

24. The method of claim 23, wherein the fluid habitat describes an environment in which the fluids in the fluid volume reside within the geological sample.

25. The method of claim 1, further comprising:
determining a hydrocarbon accommodation capacity of the subterranean area of the earth based on the pressure change over time data;
determining a gas recovery factor of the subterranean area of the earth based on the pressure change over time data;
determining a gas rate of yield of the subterranean area of the earth based on the pressure change over time data;
determining one or more rock-controlled desorption factors of the subterranean area of the earth based on the pressure change over time data;
determining a volume of gaseous rocks in the subterranean area of the earth based on the pressure change over time data;
determining a hydrocarbon yield at a surface of the subterranean area of the earth based on the pressure change over time data;
determining recoverable gas reserves of the subterranean area of the earth based on the pressure change over time data; or
combinations thereof.

26. The method of claim 1, further comprising repeating steps (a)-(e) for a second geological sample acquired from a second depth in the subterranean area to identify a second fluid volume in the subterranean area at the second depth, wherein the second depth is different from a depth of the first geological sample.

27. The method of claim 26, wherein the second depth and the depth of the first geological sample are a predetermined distance apart.

28. The method of claim 26, further comprising generating a fluid volume profile for the first depth and the second depth of the subterranean area of the earth.

29. The method of claim 1, further comprising identifying a fluid type of the geological sample based on the pressure change over time data.

30. A method for determining an optimum drawdown pressure for extracting a fluid from a subterranean area of the earth, comprising:
(a) performing a preliminary analysis on a first geological sample;
(b) placing the first geological sample inside a chamber;
(c) initializing a pressure inside the chamber to a first predetermined pressure value;
(d) monitoring a first pressure change over time data inside the chamber;
(e) crushing the first geological sample;
(f) repeating steps (a)-(e) using a second geological sample initialized at a second predetermined pressure value to obtain a second pressure change over time data;
(g) determining the optimum drawdown pressure based on the first and second pressure change over time data and the preliminary analysis.

31. The method of claim 30, wherein each geological sample was acquired at the same depth in the subterranean area of the earth.

32. The method of claim 30, wherein the pressure is adjusted using a vacuum coupled to the chamber.

33. The method of claim 30, wherein each predetermined pressure value corresponds to a pressure value for pumping the fluid volume from the subterranean area of the earth.

34. The method of claim 30, wherein crushing the first geological sample comprises reducing the volume of the first geological sample by at least 3%-6%.

35. The method of claim 30, wherein crushing the plurality of geological samples comprises reducing the volume of the first geological sample by about 33%.

36. The method of claim 30, wherein determining the optimum drawdown pressure comprises:
identifying one of the first and second pressure change over time data that has the most fluid content;
identifying a pressure value that corresponds to the identified pressure change over time data that has the most fluid content; and
scaling the identified pressure value for the subterranean area of the earth using the preliminary analysis.

37. The method of claim 30, further comprising repeating steps (a)-(g) for a plurality of geological samples acquired from a plurality of depths in the subterranean area to determine a plurality of optimum drawdown pressures for the plurality of depths.

38. The method of claim 37, further comprising identifying one or more drilled zones in the subterranean area based on the plurality of optimum drawdown pressures.

39. The method of claim 38, further comprising determining an optimum drawdown pressure for one of the drilled zones based on a subset of the plurality of optimum drawdown pressures, wherein the subset of the plurality of optimum drawdown pressures comprise one or more drawdown pressures in the one of the drilled zones.

40. A method for determining an optimum drawdown pressure for extracting a fluid volume from a subterranean area of the earth, comprising:
(a) performing a preliminary analysis on a geological sample;
(b) placing the geological sample inside a chamber;
(c) initializing a pressure inside the chamber to a first predetermined pressure value;
(d) monitoring a pressure change over time data inside the chamber;
(e) simultaneously crushing the geological sample and modifying the pressure in the chamber a plurality of times; and
(f) determining the optimum drawdown pressure based on the pressure change over time data and the preliminary analysis.

41. The method of claim 40, wherein determining the optimum drawdown pressure, comprises:
identifying a portion of the pressure change over time data that has the most fluid content; and
identifying a pressure value that corresponds to the identified portion of the pressure change over time data; and
scaling the identified pressure value for the subterranean area of the earth using the preliminary analysis.

42. The method of claim 41, wherein the portion is in a time interval between two subsequent times of the plurality of times.

43. The method of claim 40, the pressure is modified to a different pressure value at each of the plurality of times.

44. The method of claim 40, the pressure is modified using a vacuum coupled to the chamber.

45. A method for determining an optimum drawdown pressure for extracting a fluid volume from a drilled zone in a subterranean area of the earth, comprising:
(a) performing a preliminary analysis on a first plurality of geological samples that were acquired from a plurality of depths in the drilled zone;
(b) placing the plurality of geological samples inside a chamber;
(c) initializing a pressure inside the chamber to a first predetermined pressure value;
(d) monitoring pressure change over time data inside the chamber;
(e) crushing the plurality of geological samples; and
(f) repeating steps (a)-(e) for a second plurality of geological samples acquired from the plurality of depths at a second predetermined pressure value;
(g) determining the optimum drawdown pressure based on each pressure change over time data for the first predetermined pressure value and the second predetermined pressure value, and the preliminary analysis.

46. The method of claim 45, wherein the drilled zone comprises a portion of the subterranean area of the earth having a similar type of geological material.

47. The method of claim 45, wherein the plurality of depths in the drilled zone correspond to a plurality of drilling perforation locations.

48. The method of claim 45, wherein determining the optimum drawdown pressure comprises identifying one of the pressure change over time data for the first predetermined pressure value and the second predetermined pressure value that has the most fluid content.

49. The method of claim 48, further comprising scaling the one of the pressure change over time data from a mass of the geological sample to a mass that corresponds to the subterranean area of the earth, wherein the mass of the geological sample is determined by the preliminary analysis.

50. A method for determining an optimum drawdown pressure for extracting a fluid volume from a drilled zone in a subterranean area of the earth, comprising:
(a) performing a preliminary analysis on a plurality of geological samples that were acquired from a plurality of depths in the drilled zone;
(b) placing the plurality of geological samples inside a chamber;
(c) monitoring pressure change over time data inside the chamber;
(d) simultaneously crushing the plurality of geological samples and modifying the pressure inside the chamber a plurality of times; and
(e) determining the optimum drawdown pressure based on the pressure change over time data and the preliminary analysis.

51. The method of claim 50, wherein the pressure value is modified using a vacuum coupled to the chamber.

52. The method of claim 50, wherein crushing the geological sample, comprises:
(g) crushing the plurality of geological samples;
(h) waiting less than one minute; and
(i) crushing the plurality of geological samples again; and
(j) repeating steps (g)-(i) for each of the plurality of times.

53. The method of claim 50, wherein determining the optimum drawdown pressure comprises:
identifying a portion of the pressure change over time data that has the most fluid content; and
identifying the pressure inside the chamber that corresponds to the identified portion of the pressure change over time data.

54. The method of claim 53, wherein the portion is in a time interval between two subsequent times of the plurality of times.

55. A method for determining a fluid type of a geological sample from a subterranean area of the earth, comprising:
(a) placing the geological sample inside a chamber;
(b) monitoring pressure change over time data inside the chamber;
(c) crushing the geological sample; and
(d) determining the fluid type of the geological sample based on the pressure change over time data.

56. The method of claim 54, wherein determining the fluid type of the geological sample comprises identifying a theoretical pressure change over time curve that corresponds to the pressure change over time data.

57. The method of claim 54, wherein determining the fluid type of the geological sample comprises identifying a pressure change over time curve stored in a database, wherein the pressure change over time curve corresponds to the pressure change over time data.

58. The method of claim 57, wherein the database comprises a plurality of pressure change over time curves, wherein each of the plurality of pressure change over time curves corresponds to a fluid type.

59. The method of claim 54, further comprising:
repeating steps (a)-(d) for a plurality of geological samples acquired from a plurality of depths in the subterranean area to determine a fluid type for each of the plurality of geological samples; and
generating a fluid type distribution for the subterranean area based on the fluid type for each of the plurality of geological samples.

60. A method for determining an optimum surface area for fluid yield in a subterranean area of the earth, comprising:
(a) performing a preliminary analysis on a geological sample from the subterranean area;
(b) placing the geological sample inside a chamber;
(c) initializing a pressure inside the chamber to a predetermined pressure value;
(d) monitoring pressure change over time data inside the chamber;
(e) crushing the geological sample inside the chamber; and
(f) determining an optimum surface area for fluid yield based on the pressure change over time data and the preliminary analysis.

61. The method of claim 60, wherein determining the optimum surface area, comprises:
identifying a portion of the pressure change over time data that has a maximum increase in pressure;
determining a size of the geological sample that corresponds to the portion; and
scaling up the size of the geological sample to the subterranean area based on the preliminary analysis.

62. A method for determining an optimum surface area for fluid yield in a subterranean area of the earth, comprising:
(a) performing a preliminary analysis on a geological sample from the subterranean area;
(b) placing the geological samples inside a chamber;
(c) initializing a pressure inside the chamber to a predetermined pressure value;
(d) monitoring pressure change over time data inside the chamber;
(e) modifying the pressure inside the chamber at a constant or variable rate;
(f) crushing the geological sample inside the chamber; and
(g) determining an optimum surface area for fluid yield based on the pressure change over time data and the preliminary analysis.

63. The method of claim 62, wherein determining the optimum surface area, comprises:
identifying a portion of the pressure change over time data that has a maximum increase in pressure relative to the modified pressure;
determining a size of the geological sample that corresponds to the portion; and
scaling up the size of the geological sample to the subterranean area using the preliminary analysis.

64. A method for identifying potential fluid yield areas in a subterranean area of the earth, comprising:
(a) receiving a plurality of fluids-in-place measurements for a plurality of depths in a first well;
(b) generating a subterranean mapping of optimum fluid yield areas in the first well based on the plurality of fluids-in-place measurements;
(c) repeating steps (a)-(b) for a plurality of depths in a second well to generate a subterranean mapping of optimum fluid yield areas in the second well; and
(d) identifying the potential fluid yield areas based on the subterranean mapping of optimum fluid yield areas in the first well and in the second well.

65. The method of claim 64, further comprising:
(e) receiving fluid habitat information for the plurality of depths in the first well;
(f) generating the subterranean mapping of optimum fluid yield areas in the first well based on the plurality of fluids-in-place measurements and the fluid habitat information;
(g) repeating steps (a), (e) and (f) for the plurality of depths in the second well to generate the subterranean mapping of optimum fluid yield areas in the second well; and
(h) identifying the potential fluid yield areas based on the subterranean mapping of optimum fluid yield areas in the first well and in the second well.

66. The method of claim 64, further comprising:
(e) receiving fluid habitat information for the plurality of depths in the first well;
(f) receiving a plurality of optimum drawdown pressures for the plurality of depths in the first well;
(g) generating the subterranean mapping of optimum fluid yield areas in the first well based on the plurality of fluids-in-place measurements, the fluid habitat information, the plurality of optimum drawdown pressures or combinations thereof;
(h) repeating steps (a), (e), (f) and (g) for the plurality of depths in the second well to generate the subterranean mapping of optimum fluid yield areas in the second well; and
(i) identifying the potential fluid yield areas based on the subterranean mapping of optimum fluid yield areas in the first well and in the second well.

67. The method of claim 64, further comprising:
(e) receiving fluid habitat information for the plurality of depths in the first well;
(f) receiving a plurality of optimum drawdown pressures for the plurality of depths in the first well;
(g) receiving cash flow information for the plurality of depths in the first well;
(h) generating the subterranean mapping of optimum fluid yield areas in the first well based on the plurality of fluids-in-place measurements, the fluid habitat information, the plurality of optimum drawdown pressures, the cash flow information or combinations thereof.
(h) repeating steps (a), (e), (f), (g) and (h) for the plurality of depths in the second well to generate the subterranean mapping of optimum fluid yield areas in the second well; and
(i) identifying the potential fluid yield areas based on the subterranean mapping of optimum fluid yield areas in the first well and in the second well.
